(19) United States
(12) Patent Application Publication
(10) Pub. No.: US 2002/0116458 A1
(43) Pub. Date: Aug. 22, 2002

(54) Web-based dating service

(76) Inventors: Jonathan Bricklin, Edwards, CO (US); Ronald N. Shostack, Paradise Valley, AZ (US); Grady M. Werner, Chandler, AZ (US)

Correspondence Address: Paul B. Milcetic, WOODCOCK WASHBURN KURTZ, MACKIEWICZ & NORRIS LLP, One Liberty Place - 46th Floor, Philadelphia, PA, 19103, US

(21) Appl. No.: 09/826,230

(22) Filed: Apr. 4, 2001

Related U.S. Application Data
(60) Provisional application No. 60/255,672, filed on Dec. 14, 2000.

(51) Int. Cl. G06F 15/16

(52) U.S. Cl. 709/204

(57) ABSTRACT

A dating related web site incorporates a number of services of interest to subscribers seeking a compatible mate or friend. A would-be subscriber first specifies profile information including authentication information, information relating to qualities desired in a friend and mate, and a screen image icon. The profile information is stored in a database associate with a web server hosting the dating site. The subscriber can then log onto the site and advantage the of chat room environments featured at the site. Rooms are hierarchically organized into lobbies and sub-lobbies corresponding to topics and sub-topics of discussion. In addition, the lobby and sub-lobby screens indicate the concentration of compatible participants in the rooms of corresponding lobbies and sub-lobbies, thus allowing easy navigation to a desirable room. In addition to manual navigation, the site features automatic navigation allowing the user to find a chat room with compatible participants automatically once a sub-lobby is selected. Upon participating in a chat session, the user and a participant may choose a “virtual date” option featured at the site to take advantage of a private chat environment and to view a private, date-related video clip

### RELATED APPLICATIONS

This application claims the benefit of U.S. Provisional Application S.No. 60/255,672, filed Dec. 14, 2000, entitled “Web-Based Dating Service.”

### FIELD OF THE INVENTION

This invention relates generally to the field of Internet dating services and services designed to facilitate a compatible matching amongst individuals seeking companionship via the World Wide Web.

### BACKGROUND OF THE INVENTION

Recent technological advances have raised productivity levels, leading to an economic boom continuing through much of the past decade. While these advances have raised the standard of living for significant segments of the population, they have not, in general, reduced the number of hours that people work. As a result, finding the time to find a compatible mate, or viable friendship, remains as challenging as ever. In fact, as the structural economic changes experienced in recent years have led to greater geographic mobility amongst the work force, the establishment of personal relationships has become all the more difficult.

Recently, a variety of Internet related services have been offered to alleviate these problems. For example, various World Wide Web portals feature “chat rooms” allowing members of an Internet subscriber community to chat in real time. During a typical “chat room” session, a computer user with Internet access first logs in, and is then presented with a screen showing real time messages sent from other users. The messages are displayed in serial fashion along with a “handle” identifying each message sender. Thus, any user can direct a message to any other particular user, and choose to strike up a chat based on the content of the displayed message. Individuals thus have at their disposal a readily accessible, convenient form of “virtual conversation” that may be used to identify potential companions or acquaintances.

Unfortunately, although helpful, finding potential mates or companions using the Internet is sometimes still difficult. In particular, chat communities, including those featured on dating-related web sites, have proliferated to include enormous numbers of members, each generating message information in relatively undifferentiated, disorganized fashion. Consequently, finding compatible chat members may take time. Further, once a pair of users find one another and strike up a virtual conversation, the continuous stream of messages from other users may prove distracting.

Thus, what is needed is an integrated package of Internet-based date related services specifically designed to facilitate finding a suitable mate or companion. Such an integrated package would provide easily visible, continually updated compatibility-screening information for each participant in a chat environment, and could optionally guide participants to chat rooms having other compatible participants. Further, once a compatible participant is found, the package of services would preferably provide an environment conducive to one-to-one conversation and to eliciting discussion of the type of subject matter useful in determining whether to pursue a relationship further.

### SUMMARY OF THE INVENTION

The present invention addresses the above described needs. In particular, in accordance with an aspect of the present invention, a web site provider establishes a site customized to facilitate finding a companion or potential mate. More specifically, the site provides functionality for determining whether a first and second subscriber are a relationship match, the extent to which the first and second subscribers are likely compatible on a friendship level and whether or not the level of friendship compatibility exceeds certain thresholds.

To use the site, would-be subscribers first register with the site by creating a profile of information specifying the qualities they deem desirable in a mate or companion. Once registered, the subscribers have access to, and may participate in, various chat room environments.

In accordance with one aspect of the present invention, chat rooms are preferably arranged in hierarchical fashion such that each room belongs to a “sub-lobby” and each “sub-lobby” belongs to a “lobby.” The lobbies each preferably correspond to respective categories of discussion topics, with each sub-lobby designating sub-categories of discussion topics within the larger categories. In this way, a subscriber can easily navigate to a chat room dedicated to a topic of interest to the subscriber.

Further, in another aspect of the present invention, during such user navigation, lobby, sub-lobby and room selection screens feature displayed indicators showing the concentration of participants compatible with the user in each respective lobby, sub-lobby or chat room. Such compatibility indicators are determined by comparison of the user's profile with that of the current chat participants. In this way, a subscriber can navigate to a chat room having high concentration of potential mates or friends participating.

In another aspect of the present invention, a subscriber also preferably has the option to avoid manual navigation altogether by allowing the service to determine automatically the chat room having the highest concentration of compatible mates and/or friends. Once the room is determined, a screen corresponding to the determined room is displayed and the subscriber can accordingly participate in the chat.

In yet another aspect of the present invention, the site provider also features a virtual date” service whereby two chat participants choosing to do so can engage in a private chat and at the same time view a digital video clip corresponding to a romantic vacation. The one-one chat environment eliminates the distraction that may result when chat messages are continuously generated by numerous chat participants. Further, the video clip provides a convenient topic for discussion that may reveal further details about a potential mate. Further features and advantages of a system and method implemented in acordance with the present invention are made apparent in the more detailed description below.

### BRIEF DESCRIPTION OF THE DRAWINGS

FIG. 1 is a high level overview of a network environment in which aspects of the present invention may be implemented.

FIG. 2 is a block diagram depicting components of the client stations shown in FIG. 1 in greater detail.

FIG. 3 is a high level flow chart depicting a process of a user profile creation in accordance with an aspect of the present invention.

FIG. 4 is a high level flow chart depicting a process of user navigation to a desirable chat room environment in accordance with an aspect of the present invention.

FIG. 5 is a high level flow chart depicting in greater detail the step of determining the concentration of compatible participants in available chat rooms shown in FIG. 4.

FIG. 6 is a high level flow chart depicting in greater detail the step of determining a desirable chat room environment automatically as shown in FIG. 4.

FIG. 7A is a high level flow chart depicting in greater detail the step of determining if a user and a participant are a relationship match as shown in FIG. 6.

FIG. 7B is a high level flow chart depicting in greater detail the step of determining the extent to which a user and participant are a friendship match as shown in FIG. 6.

FIG. 8 is a high level flow chart depicting a user initiation of a virtual date in accordance with an embodiment of the present invention.

FIGS. 9 and 9a are web page interfaces that may be used to perform the step of selecting and forwarding a new or existing registered subscriber choice as depicted in FIG. 3.

FIGS. 10 and 10a are web page interfaces that may be used to perform the step of selecting and forwarding a screen name, password and e-mail address during registration as depicted in FIG. 3.

FIG. 11 is a web page interface that may be used to perform the step of selecting and forwarding a relationship basics choice, friendship preferences choice or screen mage choice as depicted in FIG. 3.

FIGS. 11a and 11b are player profile web page interfaces that may be used as alternatives to that shown in FIG. 11.

FIG. 12 is a web page interface that may be used to perform the step of selecting and forwarding a first set of relationship basics information as depicted in FIG. 3.

FIG. 13 is a web page interface that may be used to perform the step of selecting and forwarding a second set of relationship basics information as depicted in FIG. 3.

FIGS. 13a-13c are alternative web page interfaces that may be used to perform the step of selecting and forwarding the information depicted in FIGS. 12 and 13.

FIGS. 13d-13f are alternative web page interfaces that may be used to perform the step of selecting and forwarding the information depicted in FIGS. 12 and 13.

FIG. 14 is a web page interface that may be used to perform the step of selecting and forwarding friendship preferences information as depicted in FIG. 3.

FIGS. 14a-14c are alternative web page interfaces that may be used to perform the step of selecting and forwarding the information depicted in FIG. 14.

FIG. 15 is web page interface that may be used to perform the step of selecting and forwarding a screen image icon as depicted in FIG. 3.

FIG. 15a is an alternative web page interface that may be used to perform the step of selecting and forwarding a screen image icon as depicted in FIG. 3.

FIGS. 16 and 16a are web page interfaces that may be used to perform the step of selecting and forwarding a lobby identification as depicted in FIG. 4.

FIGS. 17 and 17a are web page interfaces that may be used to perform the step of selecting and forwarding a sub-lobby identification as depicted in FIG. 4.

FIGS. 18 and 18a are web page interfaces that may be used to perform the step of choosing a chat room as depicted in FIG. 4.

FIG. 19 is a web page interface that may be used to perform the step of providing a chat room page corresponding to a determined chat room as depicted in FIG. 4.

FIGS. 19a and 19b are alternative web page interfaces that may be used to perform the step of providing a chat room page corresponding to a determined chat room as depicted in FIG. 4.

FIGS. 19c and 19d are web page interfaces that may be used to perform the step of sending a private message to a chat participant.

FIGS. 19e and 19f are web page interfaces that may be used to perform the step of inviting a chat participant to a private room.

FIG. 19g is a web page interface that may be used to perform the step of initiating a virtual date.

FIG. 19h is a web page interface that may be used to perform the step of selecting a virtual date activity type.

FIG. 19i is a web page interface that may be used to perform the step of selecting an interactive movie for a virtual date.

FIG. 19j is a web page interface that may be used to perform the step of selecting an interactive figure to be featured in an interactive movie.

FIG. 19k is a web page interface that may be used to implement a virtual date in accordance with an embodiment of the preset invention.

FIG. 20 depicts a set of Internet relay chat servers configured in a spanning tree formation.

FIG. 21 is a web page interface that may be presented to an existing registered user of a dating related web site upon log-in in accordance with an embodiment of the present invention.

### DETAILED DESCRIPTION OF PREFERRED EMBODIMENTS

A detailed description of an exemplary embodiment of the present invention will now be described with reference to the above figures. Although this description provides detailed examples of possible implementations of the present invention, it should be noted that these details are intended to be exemplary and in no way delimit the scope of the invention.

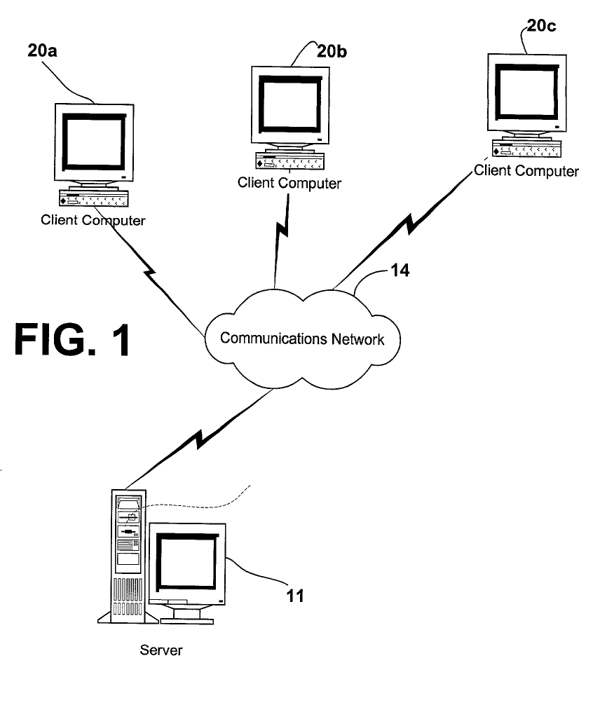

Turning now to FIG. 1, it shows a high level overview of a network environment in which aspects of the present invention may be implemented. One or more client stations 20a, b, c, can be coupled via the Public Switched Telephone Network (PSTN) to an Internet Access Provider (IAP) station. The IAP station in turn, is connected in the “Internet” 14 (i.e., the well known globally interconnected network of host servers, including World Wide Web servers 11).

According to conventional practice, an IAP subscriber at client station 20 dials a modem at the IAP station, which typically includes a rack of modems (i.e., modulator-demodulators) which can then accept multiple incoming calls simultaneously. The call is completed over the PSTN by a switching station at the central office of a telephone service provider. Once the call to the IAP station is completed, the client station 20 is connected in the Internet 14, and the client station 20 can issue data requests to web sites on web servers 11 using the IAP station as a conduit. In an alternative embodiment, the client station 20 maintains a permanent connection to the Internet 14 using a network or similar interface, in which case dialing in is not required.

Thus, while connected in the Internet, the IAP subscriber may access an information database (i.e., the Internet 14) spanning the globe much as if such information were stored locally at the subscriber's client station 20a,b,c.

A number of protocols are used to exchange commands and data between computers connected to the Internet. The protocols include the File Transfer Protocol (FTP), the Hyper Text Transfer Protocol (HTTP), the Simple Mail Transfer Protocol (SMTP), and the Gopher document protocol. The HTTP protocol is used to access data on the World Wide Web, often referred to as “the Web.” The Web is an information service on the Internet providing documents and links between documents. It is made up of numerous Web sites located around the world that maintain and distribute electronic documents. A Web site may use one or more Web server 11 computers that store and distribute documents in a number of formats, including the Hyper Text Markup Language (HTML). An HTML document contains text and metadata (commands providing formatting information), as well as embedded links that reference other data or documents. The referenced documents may represent text, graphics, or video. The presently described embodiment is thus described below with reference to an IAP subscriber or user having access to a web server 11 having HTML documents representing web pages. The web pages together facilitate Web based dating services in accordance with an embodiment of the present invention.

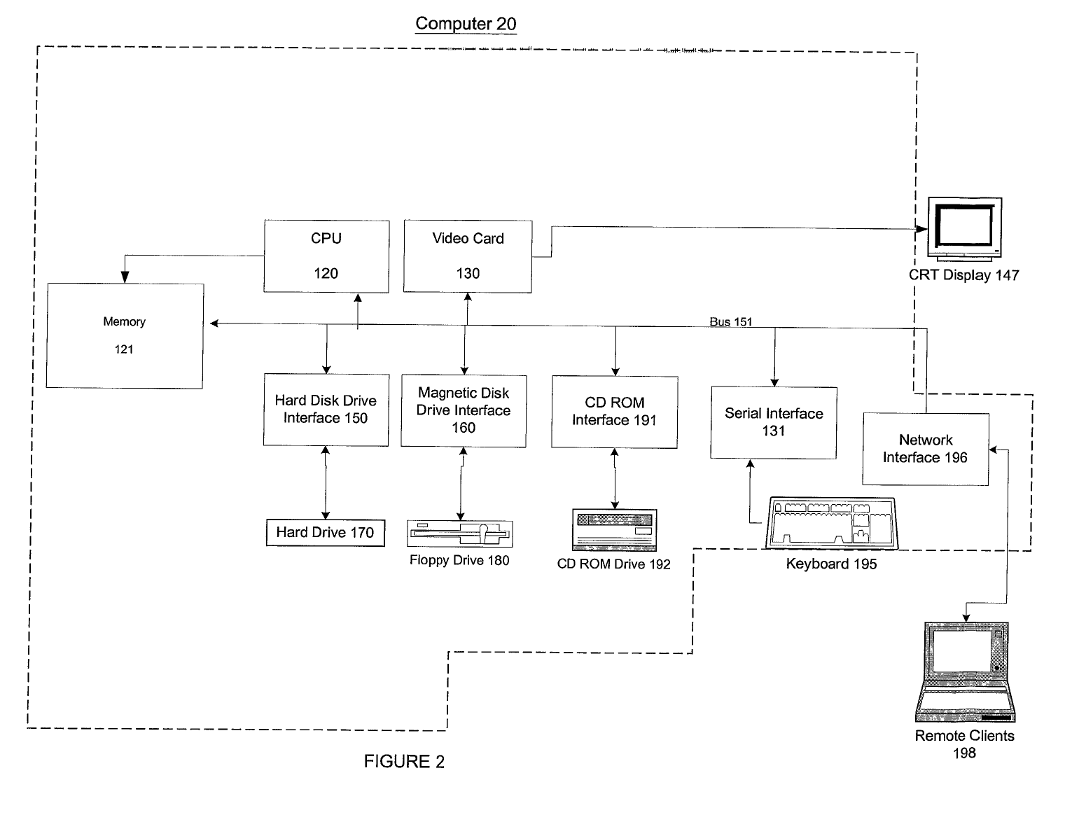

Turning now to FIG. 2, it is a block diagram depicting components of the client stations 20 shown in FIG. 1 in greater detail. In particular, the client station 20 in FIG. 1 includes conventional computer hardware components including a Central Processing Unit (“CPU”) 120, a system memory 121, and a system bus 151 that couples the system memory 121 to CPU 120 and other computer system 20 components. The system memory 121 typically includes read only memory (ROM), random access memory (RAM) or other conventional known memory types. Instructions comprising application program modules, including an operating system, are typically stored in and retrieved from memory 121 by CPU 120, which executes said instructions. In particular, in the presently described embodiment, a user's client incorporate application program modules that include a browser element. A Web Browser is a client application or an integrated operating system utility that communicates with server computers via FTP, HTTP and Gopher protocols. In the presently described embodiment, a Web browser functions to request and receive web pages and data from a web server 11 storing Internet Dating web site service and to graphically present the web pages to a user on a display device.

The display device 147 is also coupled to the system bus 151 via a video graphics adaptor card 130. The display device 147, which may be a CRT monitor, LCD terminal or other display, includes a screen for the display of information visible to the user.

The user controls the web browser by entering commands and other input into the computer 20 via input devices such as a keyboard 195, mouse, scanner or other input device. In the exemplary computer system illustrated, the keyboard 195 is coupled to CPU 120 via a serial port 131 coupled to system bus 151.

As noted above, the present invention includes an Internet based dating web site providing a variety of services useful to those individuals seeking a friend or mate. In the presently described embodiment this site consists of web pages comprising HTML data requested and graphically interpreted by the user's web browser.

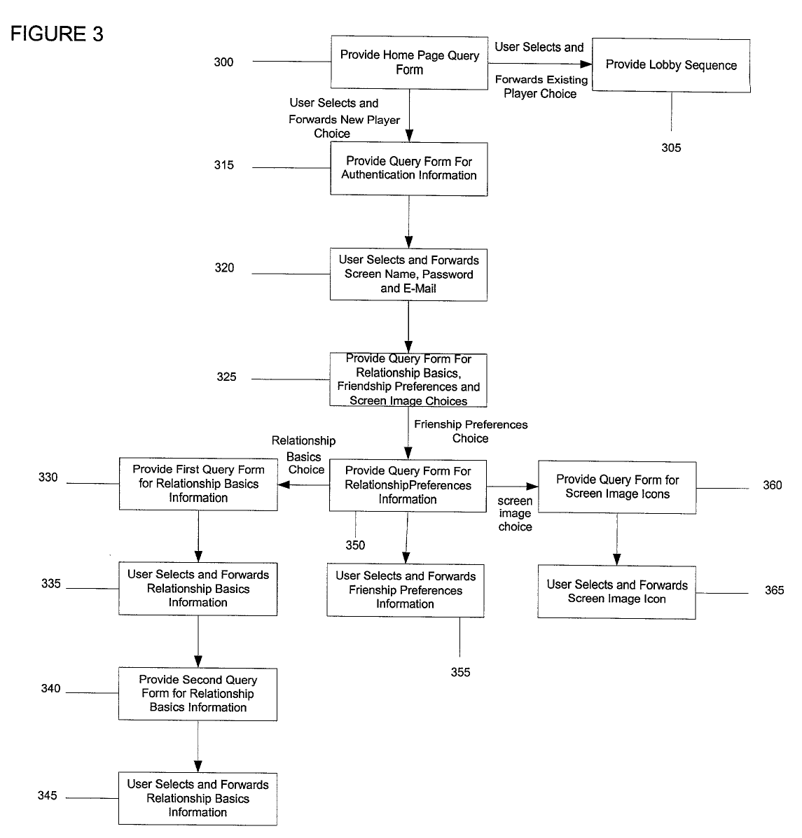

Turning now to FIG. 3, it is a high level flow chart depicting a process of new subscriber registration at such a web site, including profile subscriber creation, in accordance with an embodiment of the present invention.

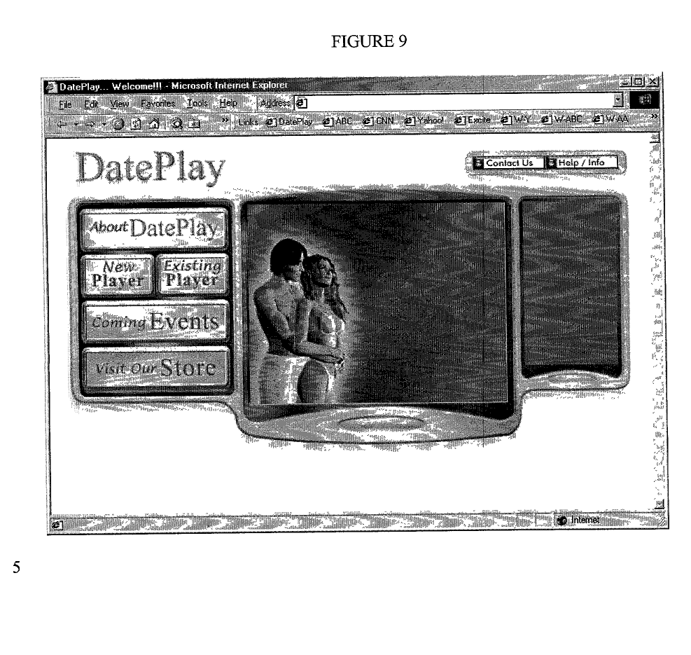

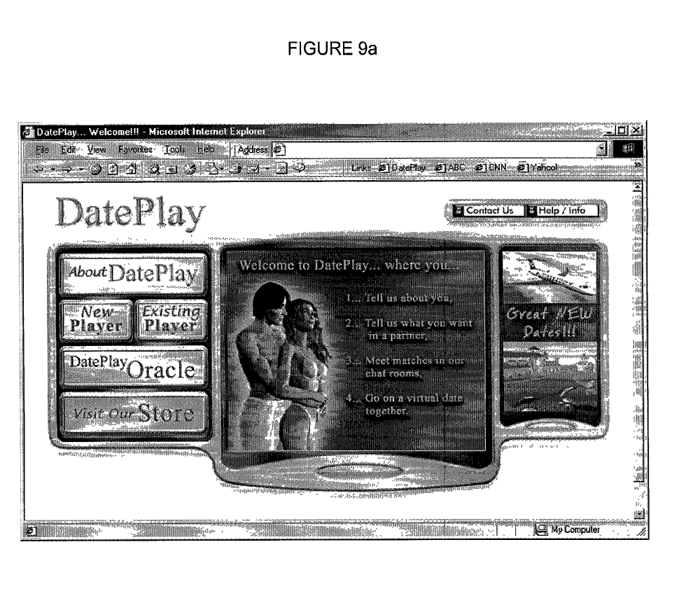

In particular, in Step 300 and in accordance with conventional processes, upon a user's keying of a URL (or selection of a displayed web page hyperlink), the client station 20 browser forwards an http request for a the Internet Dating service home page to the site provider's web server 11 or to a web server 11 hosting the site provider's site. In response, the web server software causes the corresponding home page consisting of HTML data to be returned to the client station 20. The web page returned includes an image map having image-based parts with corresponding hyperlinks allowing the user to specify whether he/she is new to the site or is already a registered subscriber. For example, FIG. 9 depicts an exemplary “home page” web page interface with “new player” and “existing player” selections as displayed on display device 147. FIG. 9a depicts a similar “home” page in accordance with an alternative embodiment.

Thus, in response to the home page with image maps, the user selects either the “new player” choice or “existing player” choice and causes the browser element to forward the choice to the site provider's web server 11. The web server 11, in turn, receives the user request and extracts data corresponding to the user's selected choice.

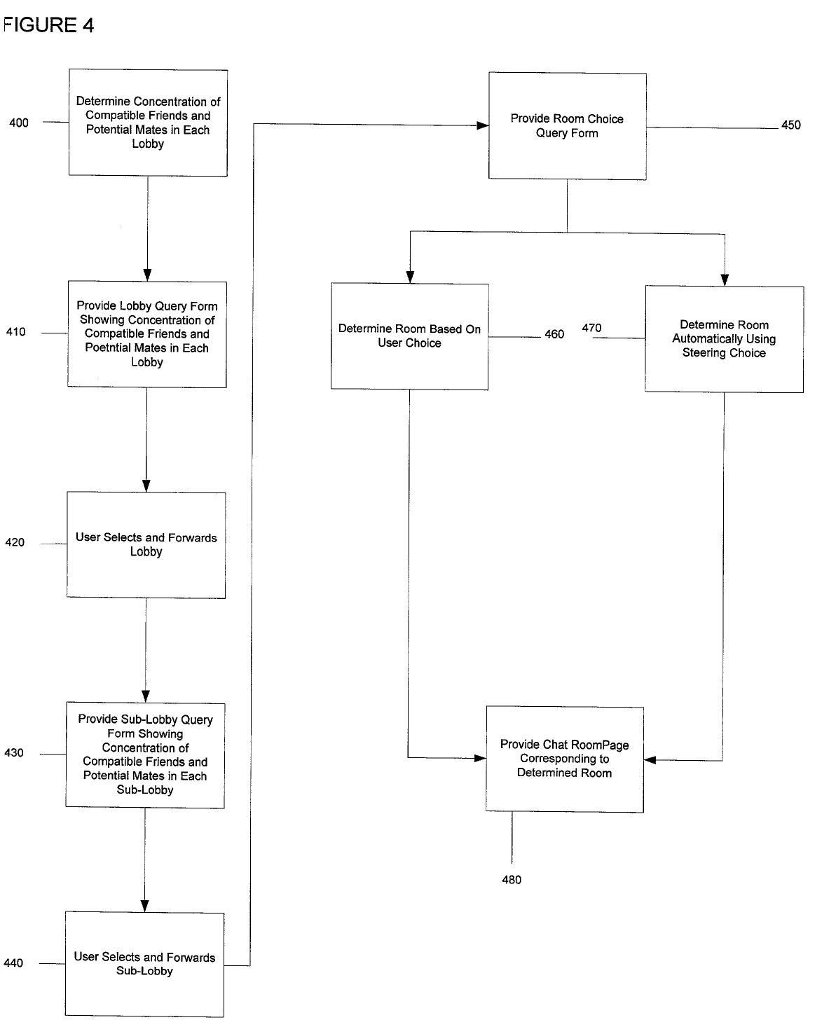

In Step 305, if the user has selected the “existing player” choice, then the web server 11 returns a log-on screen allowing the user to authenticate himself/herself as an existing subscriber. Once authentication information is provided, a web page is returned initiating a process, in accordance with an embodiment of the present invention, of user navigation to a desirable chat room environment having participants compatible with the user. This process is described in greater detail below with reference to FIG. 4.

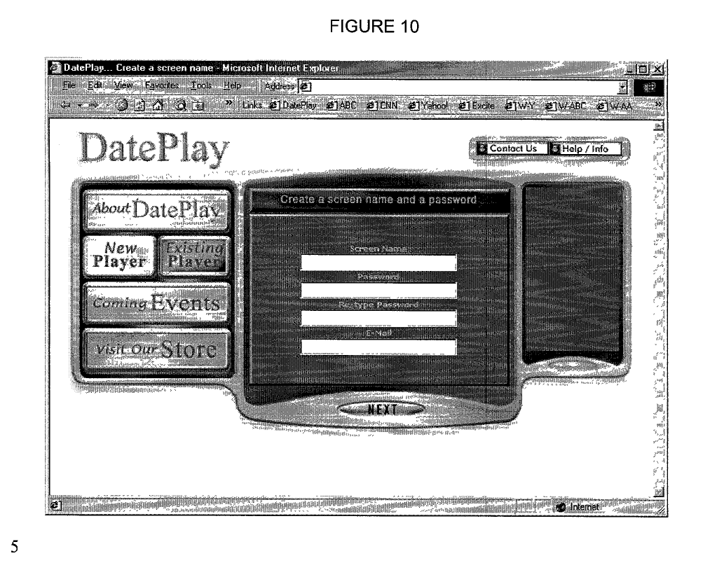

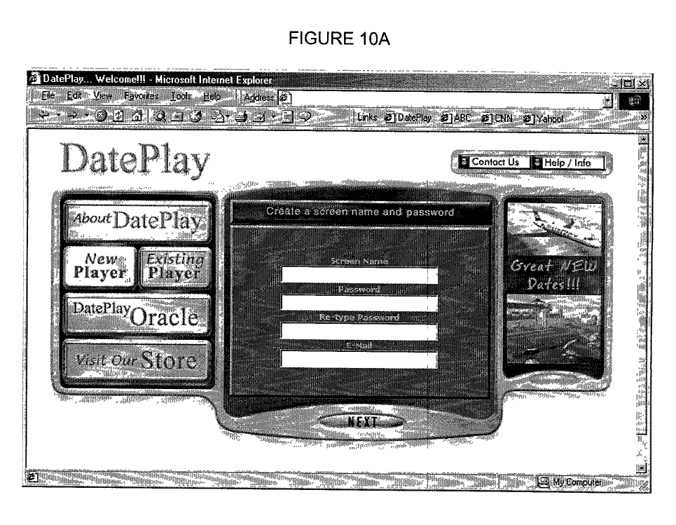

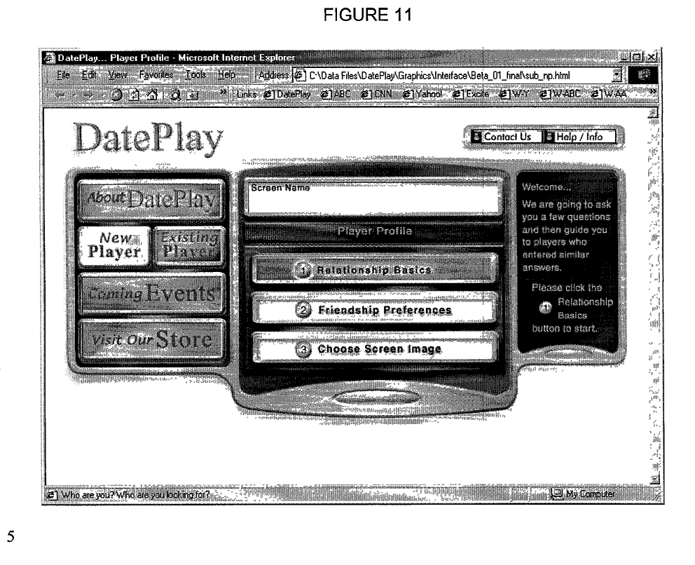

If however the user selected the “new player” button, then in step 315 of FIG. 3 the web server 11 returns a query form page initiating a process of subscriber profile creation in accordance with an embodiment of the present invention. In particular, the web server 11 first returns a query form page allowing entry of authentication information corresponding to the user in a user profile stored at the web server 11 and maintained by site provider. For example, FIG. 10 depicts an exemplary query form page interface allowing entry of a screen name, password, re-entry of password and electronic mail address information. FIG. 10a depicts a similar query from page in accordance with an alternative embodiment.

The screen name corresponds to a name the user will go by as a chat participant when using the virtual chat services provided by the web site. The screen names need not correspond to the user's actual name and thus allows for some anonymity during chat participation. The password will allow the user to log onto the web site as an existing subscriber in future access sessions, and will also allow the web server 11 to identify and retrieve the user's profile thus obviating the need for profile re-creation prior to each access session. The password re-entry field allows confirmation of the password typed in by the user. Finally, the electronic mail address field allows entry of the user's electronic mail address. This e-mail information allows the site provider to communicate with subscribers (for example, to provide a forgotten password or to provide dating, vacation or singles related special offers to the user).

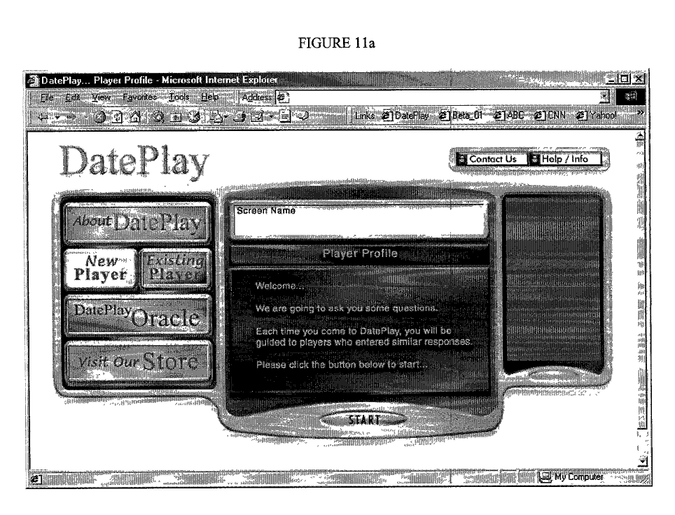

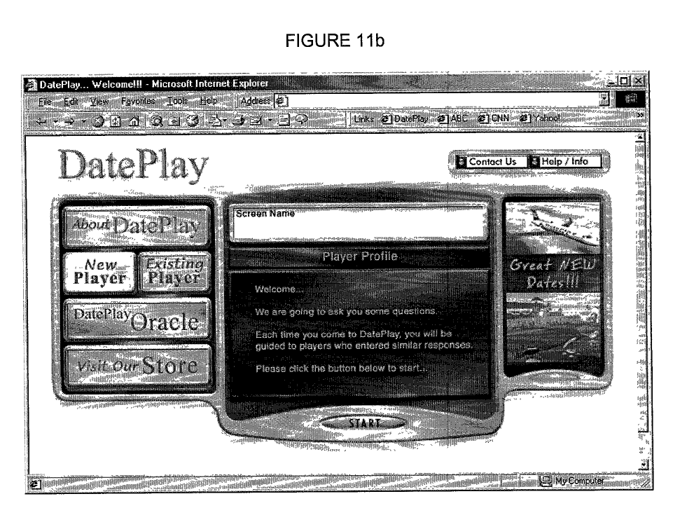

Thus, in Step 320, the user specifies screen name, password and electronic mail information and causes the browser element to forward the selections to the site provider's web server 11. The web server 11, in turn, receives the user request and extracts and stores data corresponding to the user's selected choices in a user profile corresponding to the user. Further, in response the web server 11 returns a query form page initiating a process for completing the subscriber profile. For example, in accordanc with alternative embodiments, FIGS. 11a and 11b depict exemplary web page displays that may notify the user that this process has begun. However, in the presently described embodiment, the user has a choice of completing selected portions of a player profile. In that case, the player profile completion process is initiated with a screen such as FIG. 11, which depicts an exemplary web page with image maps with conventional displayed “buttons.” The exemplary web page of FIG. 11 allows entry of a relationship basics choice, a friendship preferences choice or a screen image icon choice. That is, the displayed buttons correspond to “relationship basics,” “friendship preferences,” or “screen image icon” choices. The “relationship basics” information selection initiates a process allowing the user to specify those qualities he or she desires in a mate. The “friendship preferences” choice initiates a process allowing the user to specify those qualities he or she desires in a friend. Finally, the “screen image icon” choice allows a user to specify a graphics image corresponding to the user that is displayed for the benefit of other participants whenever the user participates in chat sessions facilitated at the web site. The screen image icon may be an actual picture of the user or may be chosen from a predefined set of icons maintained by the site provider.

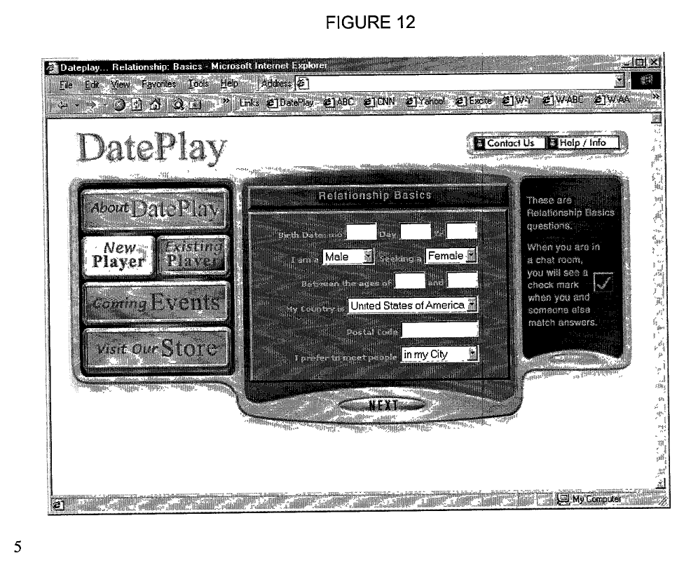

In Step 330, if the user has selected the “relationship basics” choice, then the web server 11 returns a web page query form allowing entry of a first set of information specifying the qualities the user desires in a mate. For example, FIG. 12 depicts an exemplary web page interface allowing user entry of a first set of “relationship basics” information. Here, the “seeking” field allows entry a gender for the desirable mate. The “I prefer to meet people” field allows the user to specify that he wishes to date only individuals in his city, region or country, as the case may be. The web server 11 can use this information in conjunction with information specified in the “postal code” and “county” fields to determine the geographic area within which the user desires to find a mate. The desired age range field allows the user to specify the age range of the user's desired mate.

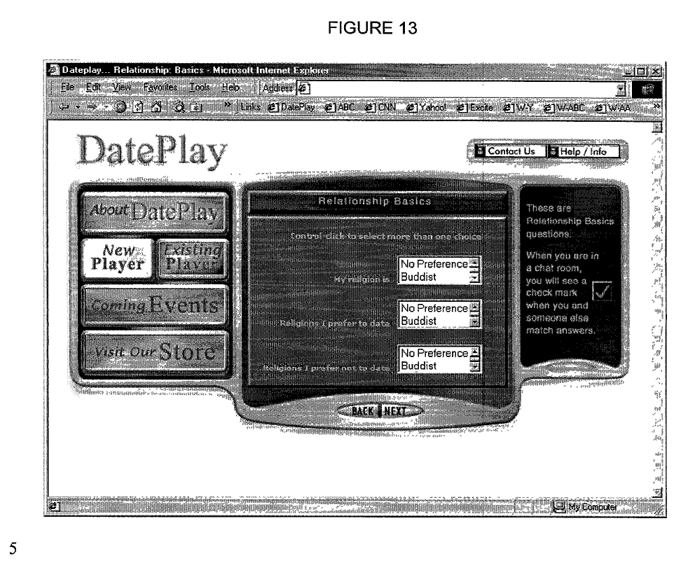

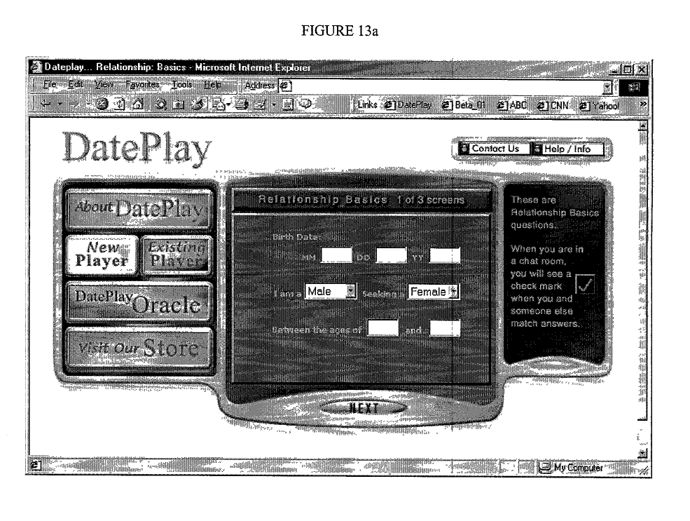

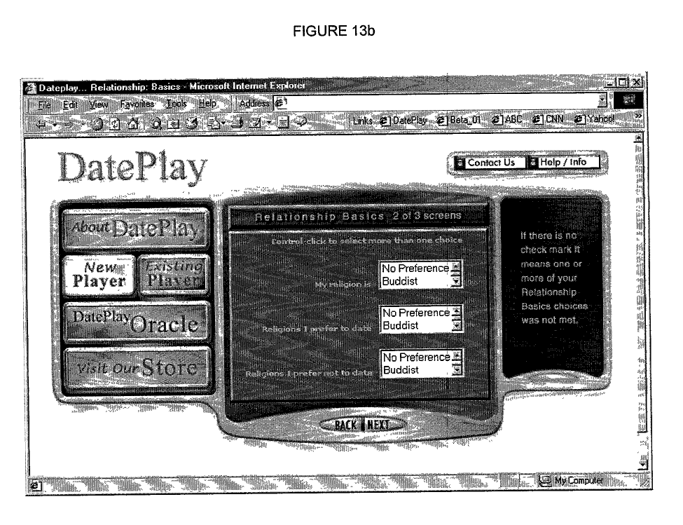

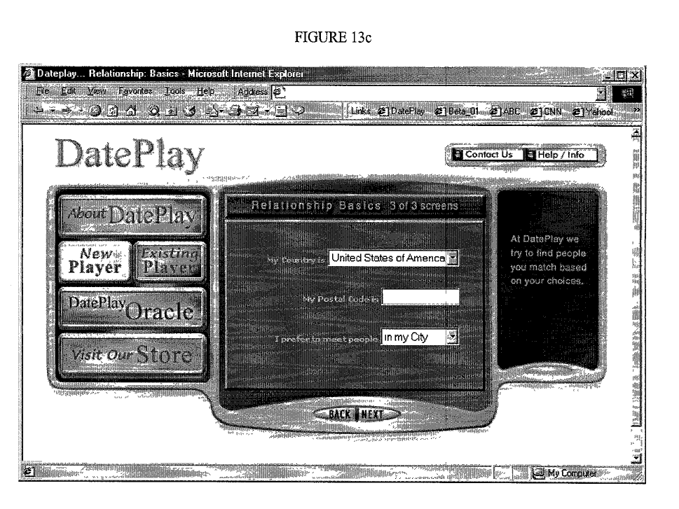

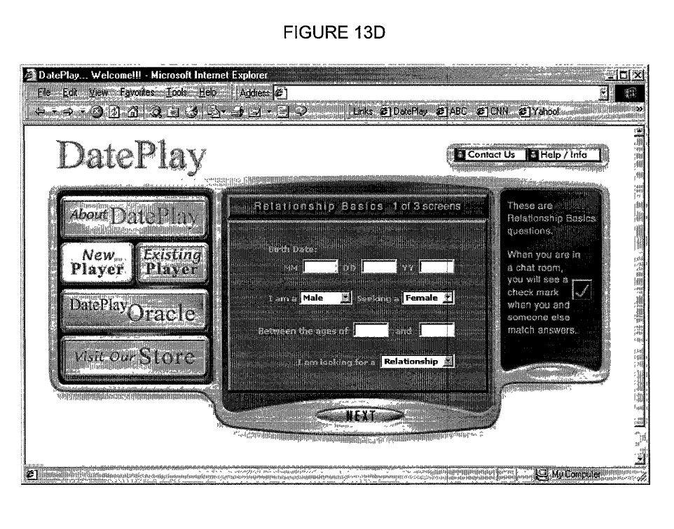

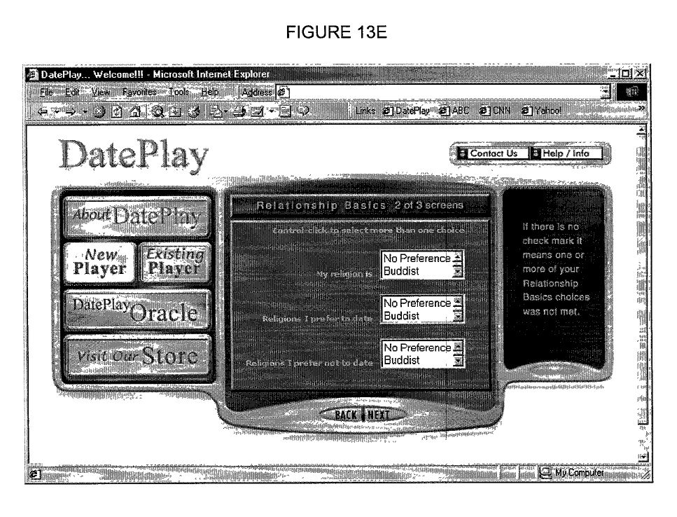

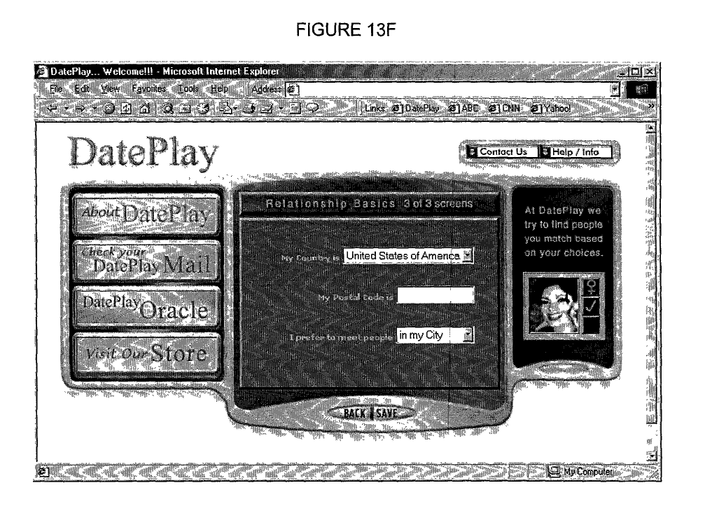

Thus, in Step 335, the user specifies user's date of birth, user's gender, mate's desired gender, age criteria for desired mate, user's country, and geographic criteria for desired mate information and causes the browser element to forward the selections to the site provider's web server 11. The web server 11, in turn, receives the user request and extracts and stores data corresponding to the user's selected choices in a user profile. Further, in response, in step 340, the web server 11 returns a query form page allowing the entry of still further information specifying the qualities the user desires in a mate. For example, FIG. 13 depicts an exemplary web page interface allowing user entry of a second set of “relationship basics” information. Here, the “religions I prefer to date” field allows entry of a religion(s) for the user's desirable mate. The “religions I prefer not to date” field allows the user to specify that he/she does not wish to date individuals belonging to the specified religions.

Thus, in Step 345, the user specifies information in the “My religion is,” “Religions I prefer to date” and “religions I prefer not to date” fields and causes the browser element to forward the selections to the site provider's web server 11, thus completing the user specification of the relationship basics portion of the profile. Note that in alternative embodiments, the relationship basics may be selected and forwarded to the web server 11 two, four or any other number of screens. For example, in accordance with an alternative embodiment, FIGS. 13a-13c depict screen interfaces for selecting and forwarding the relationship basics information using three screens instead of two. In accordance with yet another alternative embodiment, FIGS. 13d-13f similarly depict three screen interfaces for selecting and forwarding relationship basics information. In this alternative embodiment, the user may also select and forward a relationship type (i.e., friendship or romantic relationship).

Turning back to the presently described embodiment, upon receiving the relationship basics information the web server 11 extracts and stores data corresponding to the user's selected choices in a user profile corresponding to the user. The web server 11 also returns a web the page (as in Step 325) allowing entry of a relationship basics choice, a friendship preferences choice or a screen image icon choice (as exemplified in FIG. 11).

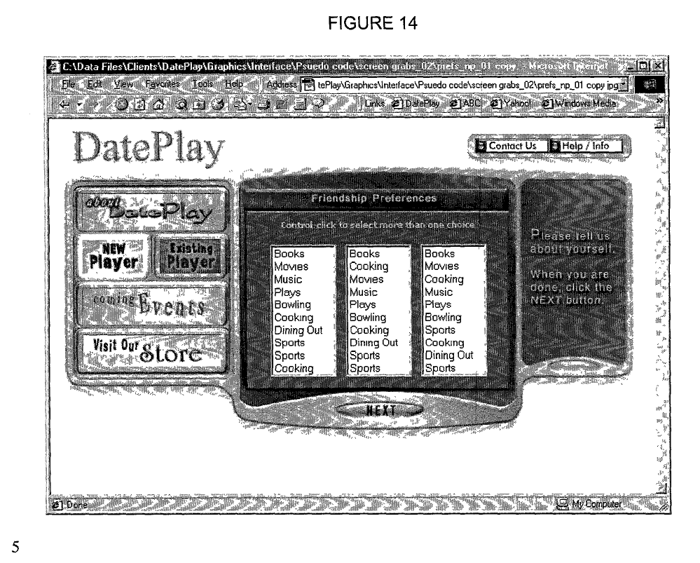

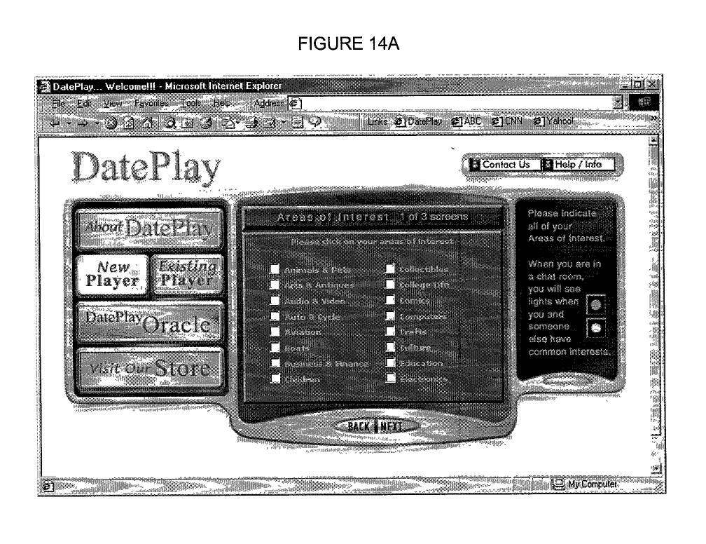

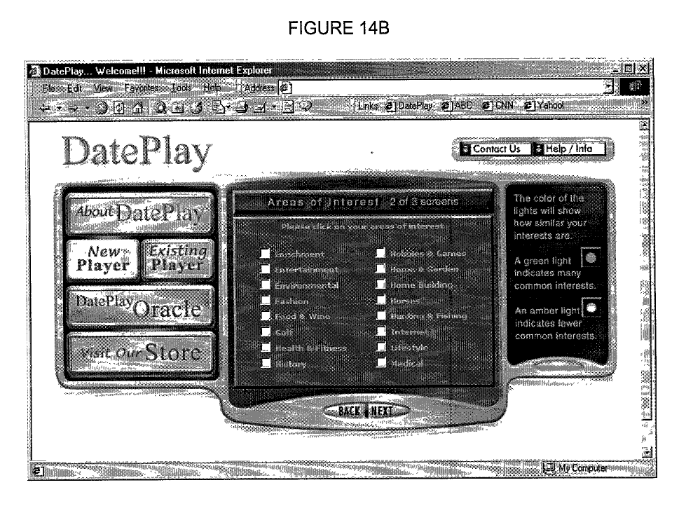

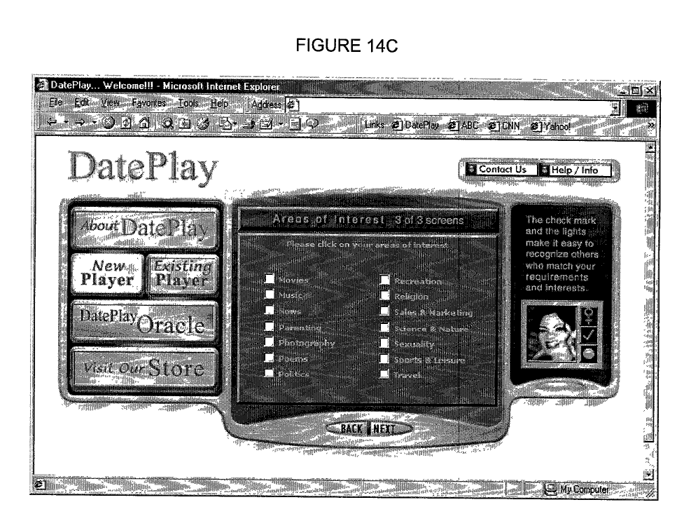

In the presently described example, the user wishes to complete the profile with information relating to the qualities he/she desires in a friend. Thus, when the user has selected the “friendship preferences” choice, in Step 350, the web server 11 returns a web page query form allowing entry of a set of information specifying areas of interest (e.g., books, movies, cooking) to the user. FIG. 14 depicts an exemplar of such a web page interface. Here, each of three menus allow specification of multiple areas of interest that can be later compared with areas of interest of other site participants to determine compatibility with the user. Note that in the presently described embodiment the items selected in the second and third columns displayed in FIG. 14 will be different than those selected in the first column. Note also that in alternative embodiments, the area of interest information may be selected and forwarded to the web server 11 with two, three or any other number of screens. For example, FIGS. 14a-14c depict screen interfaces for selecting and forwarding the are of interest information using three screens with check boxes instead of one screen with pull down menus.

Turning back to the presently described embodiment, once the user specifies the area of interest information in Step 355 the browser element then forwards the selections to the site provider's web server 11. The web server 11, in turn, receives the user request and extracts and stores data corresponding to the user's selected choices in a user profile corresponding to the user. The web server 11 also returns a web the page (again as in Step 325) allowing entry of a relationship basics choice, a friendship preferences choice or a screen image icon choice (as exemplified in FIG. 11).

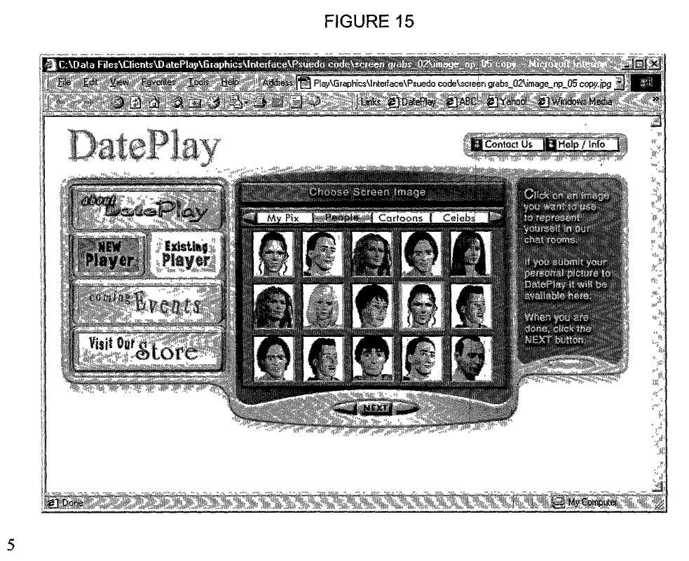

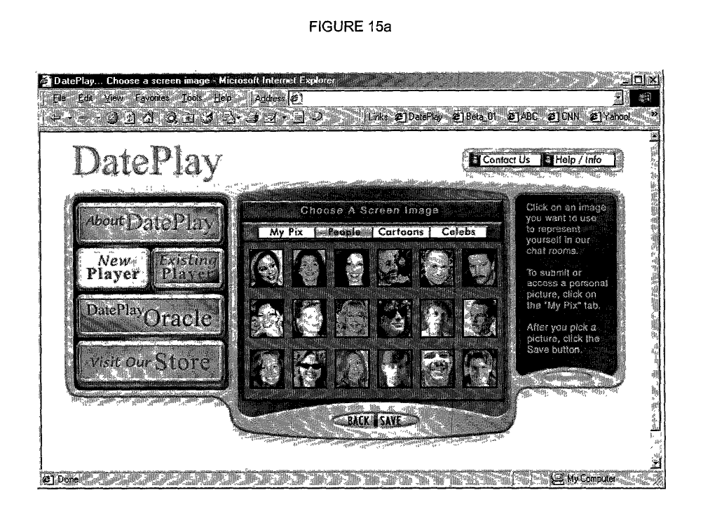

In the presently described example, the user wishes to complete the profile with information relating to the screen icon he/she wishes to present to other participants during chat sessions. Thus, when the user has selected the “screen image” choice, in Step 360, the web server 11 returns a web page query form allowing entry of a set of information corresponding to a screen icon representing the users. FIG. 15 depicts an exemplar of such a web page interface. The interface provides a series of predefined screen icons from which the user may choose. Thus, in Step 365, the user specifies an icon and selects the “next button” causing the browser element to forward the selection to the site provider's web server 11. In an alternative embodiment, the user creates a digital photo of him or herself (e.g., using conventional scanning processes) and forward the picture to the site provider (e.g., via electronic mail or via a special screen interface). For example, FIG. 15a depicts a web page interface allowing a choice among screen image icons forwarded to the site provider earlier.

Once the user's relationship basics, friendship preferences and screen image is specified, the user profile is complete and the user can log on as an existing subscriber of the site in future site access sessions. Further, as the option of changing aspects of his or her corresponding profile by aspects of the profile. For example, upon logging on as an existing subscriber the user may choose the “relationship basics,” “friendship preferences,” or “screen image” choices, as in step 325 of FIG. 3, to re-define those respective aspects of the profile. Each time the profile is redefined in this manner an updated version of the profile is stored on the web server 11 or in a database associated with the web server 11 maintained by the site provider.

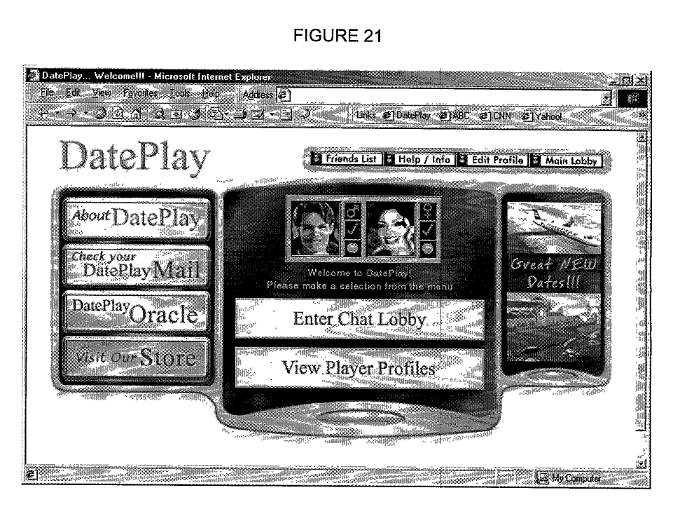

In addition, upon logging on as an existing subscriber the user can take advantage of the relationship facilitation services provided by the dating related web site. For example, in the presently described embodiment, upon logging in as an existing user, the user is presented with a screen such as that depicted in FIG. 21 allowing the user to take advantage of on line chat room and other services facilitated by the dating related web site. If the user selects the “View Player Profile” option, the user is directed to a screen that enables the user to view the information assembled about a player in the corresponding player profile. In that event, the user ca send e-mails to such other players that seem interesting.

If the user selects the “Enter Chat Room” button, the user is presented with the ability to arrive at a desired chat room environment by navigating to a chat room with participants having relative compatibility with the user. This navigation is made easier by the hierarchical organizations of chat rooms featured at the dating related web site. In particular, in the presently described embodiment, the chat rooms are organized into sub-lobbies, which in turn are organized into lobbies. In an advantageous aspect of the present invention, the lobbies each correspond to a broad category of conversation topic characterizing the subject of the chat in each chat room within the lobby. Further, each room within a sub-lobby features sub-topics of conversation falling within the broad topic associated with the lobby within which the sub-lobby is organized. A user can thus find a chat room featuring an optimal chat topic by selecting a broad topic of interest (e.g., sports) on the lobby level, a narrower sub-topic of interest falling within the broad topic (e.g., hockey) on the sub-lobby level, and then a chat room within the selected sub-lobby.

In another advantageous aspect of the present invention, the web-page interfaces corresponding to the lobby, sub-lobby and chat room selections provide feedback indicating the concentration of compatible participants in each lobby, sub-lobby or chat room, as the case may be. In this way, the user's selection of chat rooms may be based not only on a favorable topic of conversation featured at the chat room, but also on the likelihood that a greater percentage of participants are compatible with the user. For example, FIG. 4 depicts a process of subscriber navigation to a desirable chat room in accordance with an embodiment of the present invention. The process described assumes the user has already logged on as an existing subscriber and intends to participate in a chat.

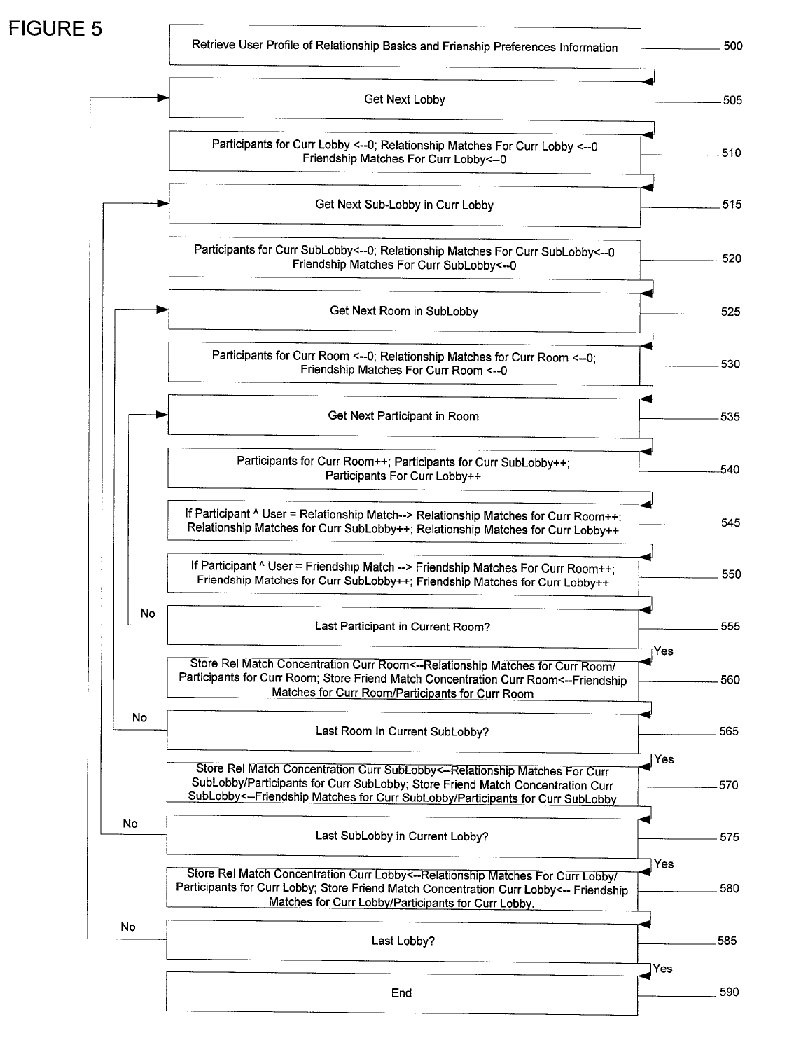

Before providing the lobby/sub-lobby/room sequence, in order to provide the compatibility and screening feedback discussed above, the web server 11 (or an associated server) in Step 400 determines the concentration of compatible participants in each room, sub-lobby and lobby within which a chat is taking place. This step depicted in greater detail in FIG. 5 in accordance with an embodiment of the present invention. In particular, in Step 500 of FIG. 5, the web server 11 first retrieves the user's profile from storage in a database. In the presently described embodiment, the user's profile is filled completely as describe above in connection with FIG. 3, though in other embodiments the profile may be partially filled with only relationship related information or only friendship related information.

Next, in Step 505, the web server 11 retrieves a first lobby from a stored set of lobbies (e.g., a “sports” lobby). In particular, data corresponding to the set of lobbies is preferably stored in a relational database configured with associations or links specifying the hierarchical relationship between lobbies, sub-lobbies within lobbies and rooms within sub-lobbies as described above. Once the first lobby is retrieved (e.g., by retrieval of a lobby identifier), in Step 510, variables having information corresponding to this particular lobby are initialized. In particular, “Participants,” “Relationship Matches,” and “Friendship Matches” variables are set to zero.

Next in Step 515, the first sub-lobby within the retrieved lobby having an active chat room is retrieved from the relational database of lobby, sub-lobby and chat room information. As with the lobby, variables having information corresponding to this particular sub-lobby are then initialized in Step 520. That is, “Participants,” “Relationship Matches” and “Friendship Matches” variables are set to zero.

Next in Step 525, the web server 11 retrieves the first active chat room within the retrieved sub-lobby from the relational database of lobby, sub-lobby and chat room information. To perform this task, the web server 11 also checks which chat rooms within the current sub-lobby are active. As with the sub-lobby, variables having information corresponding to this particular room are then initialized in Step 530. That is, “Participants,” “Relationship Matches” and “Friendship Matches” variables are set to zero.

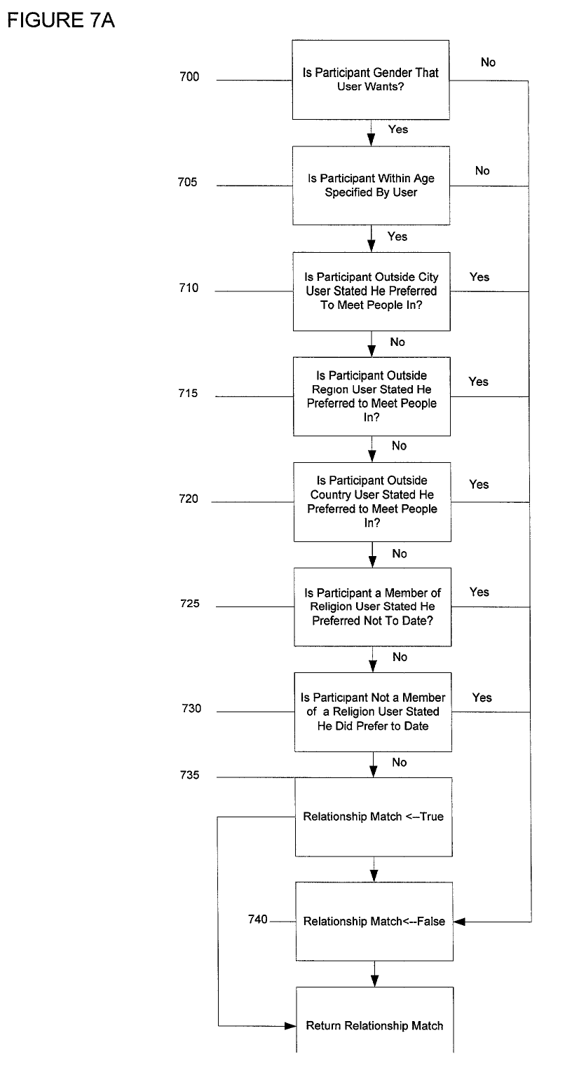

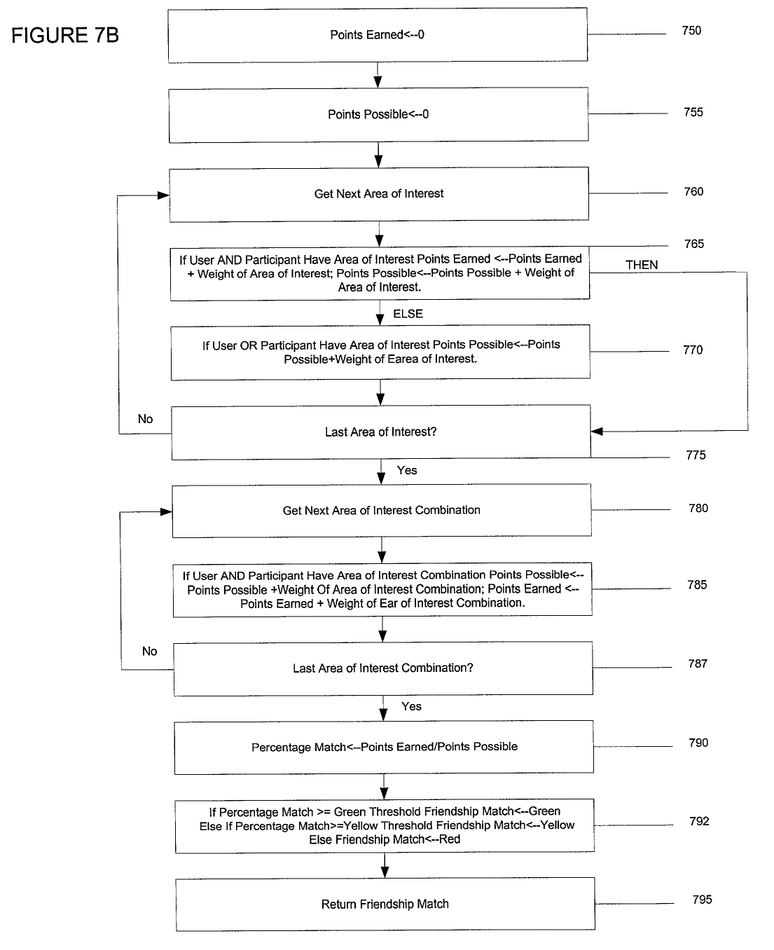

Next in Step 535, the first participant within the retrieved chat room is retrieved by checking for the participants active in the room. At the same time, the “Participants” variables for the current lobby, sub-lobby, and room are incremented by one in Step 540 and the participant's profile stored at the web server 11 (or associated database) is retrieved for comparison with user's. In particular, in Step 545 the web server 11 compares the participant's profile to the user's to determine whether there is a relationship match between the two. An exemplary process for determining whether there is a relationship match between two subscribers of the dating-related web site in accordance with an embodiment of the present invention is described more full in connection with FIG. 7A below. If such a procedure returns a relationship match, then the “Relationship Matches” variables for the current lobby, sub-lobby and room are also incremented by one. Similarly, in Step 550 the web server 11 compares the participant's profile to the user's to determine the degree to which there is a friendship match between the two. If such a procedure returns a sufficient degree friendship compatibility, then the “Friendship Matches” variables for the current lobby, sub-lobby and room are also incremented by one. An exemplary process for determining the degree of friendship compatibility between two subscribers of the dating-related web site, as well as the threshold degree of compatibility necessary to be deemed a friendship match, in accordance with an embodiment of the present invention, is described more full in connection with FIG. 7B below.

In Step 555, the web server 11 determines whether the current participant is the last in the currently considered chat room. If not then the next participant in the room is retrieved along with a corresponding profile and the process of Steps 540-555 is repeated. In this way the process is repeated for each participant in the room and thus eventually yields the number of participants in the room, the number of such participants that are relationship matches and the number of such participants that are friendship matches. Thus, once the web server 11 determines during an iteration of Step 555 that there are no more participants, in Step 560 the web server determines the concentration of relationship matches and friendship matches in the room processed. That is, a “Relationship Match Concentration” variable for the current room is set to the number of relationship matches over the number of participants and is stored for future retrieval at the web server 11 or an associated database. Similarly, a “Friendship Match Concentration” variable for the current room is set to the number of friendship matches over the number of participants in the room and is stored.

Next, in Step 565, the web server 11 determines whether the current room is the last in the currently considered sub-lobby. If not then the next room in the sub-lobby is retrieved and the process of Steps 530-565 is repeated. In this way the process is repeated for each room in the currently considered sub-lobby. This ensures that relationship match and friendship match concentration data for each room in the sub-lobby is stored and also eventually yields the number of participants in the sub-lobby, the number of such participants that are relationship matches and the number of such participants that are friendship matches. Thus, once the web server 11 determines during an iteration of Step 565 that there are no more rooms in the sub-lobby, in Step 570, the web server can determine the concentration of relationship matches and friendship matches in the sub-lobby processed. That is, a “Relationship Match Concentration” variable for the current sub-lobby is set to the number of relationship matches in the sub-lobby over the number of participants in the sub-lobby and is stored for future retrieval at the web server 11 or an associated database. Similarly, a “Friendship Match Concentration” variable for the current sub-lobby is set to the number of friendship matches for the current sub-lobby over the number of participants in the current sub-lobby and is stored.

Next, in Step 575, the web server 11 determines whether the current sub-lobby is the last in the currently considered lobby. If not then the next sub-lobby in the current lobby is retrieved and the process of Steps 520-575 is repeated. In this way the process is repeated for each sub-lobby of rooms in the currently considered lobby. This ensures that relationship match and friendship match concentration data for each room in each sub-lobby in the currently considered lobby is stored and also eventually yields the number of participants in the current lobby, the number of such participants that are relationship matches and the number of such participants that are friendship matches. Thus, once the web server 11 determines during an iteration of Step 575 that there are no more sub-lobbies in the current lobby, in Step 580, the web server can determine the concentration of relationship matches and friendship matches in the lobby processed. That is, a “Relationship Match Concentration” variable for the current lobby is set to the number of relationship matches in the lobby over the number of participants in the lobby and is stored for future retrieval at the web server 11 or an associated database. Similarly, a “Friendship Match Concentration” variable for the current lobby is set to the number of friendship matches for the current lobby over the number of participants in the current lobby and is stored.

Finally, in Step 585, the web server 11 determines whether the current lobby is the last. If not then the next lobby is retrieved from the database of lobby/sub-lobby/room information the process of Steps 510-585 is repeated. In this way the process is repeated for each lobby of sub-lobbies having active chat rooms. This ensures that relationship match and friendship match concentration data for each room and sub-lobby of rooms in each lobby, as well as for each lobby, is eventually stored, completing the process. Once the server 11 determines during an iteration of Step 585 that there are no more lobbies, the process ends in Step 590.

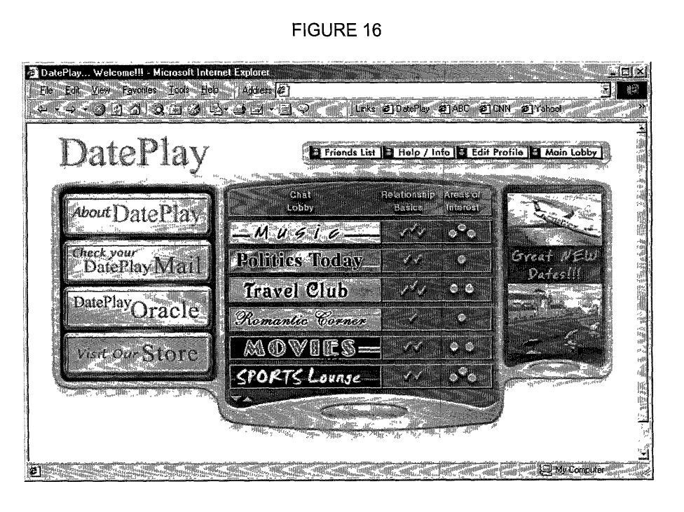

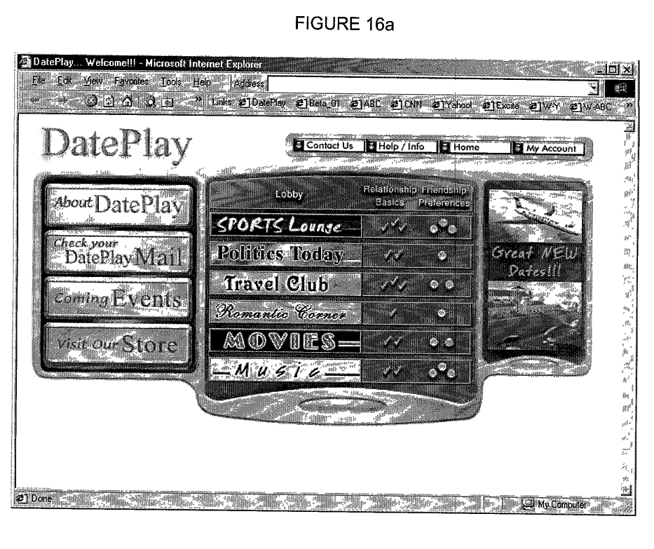

Thus, now turning back to FIG. 4, the web server 11 having determined and stored the concentration of compatible friends and potential mates in each active room, sub-lobby and lobby, the process of subscriber navigation to a desirable chat room may begin. That is, in Step 410, in response to an “Enter Chat Room” selection by an existing subscriber the web server 11 returns a query form page initiating a process for navigating through the available chat room lobbies. In particular, the web server 11 returns a web page allowing entry of a sports lobby choice, a politics lobby choice, a travel, lobby choice, a romantic conversation lobby choice, a move/film lobbies choice and a music lobby choice. For example, FIG. 16 depicts an exemplary web page with image maps with conventional displayed “buttons” corresponding to these choices. FIG. 16a depicts a similar web page in accordance with an alternative embodiment.

As noted above, the lobbies are preferably stored in a relational database specifying the associations amongst lobbies, sub-lobbies and rooms. Also, in a further aspect of the present embodiment, the web page of FIG. 16 also displays indicators showing the concentration of compatible friends and mates in each active lobby. Here, the displayed indicators comprise one to three check marks reflecting the concentration of compatible mates and one to three green lights reflecting the concentration of compatible friends. Again, this information relating to the concentration of compatible participants is derived from the concentration variables stored in Step 400 of FIG. 4 and determined in accordance with the discussion of FIG. 5. By providing for the display of indicators showing the concentration of likely compatible friends and mate, the dating related web site allows more informed user navigation to a desired chat room.

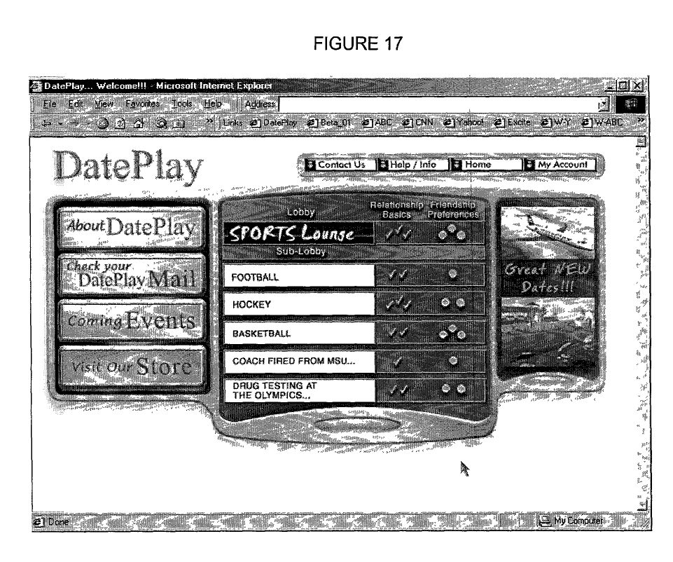

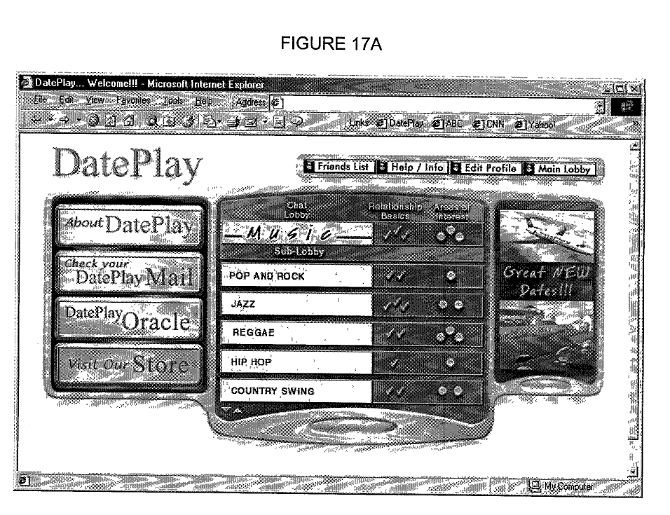

In the presently described embodiment, the user selects the “sports lounge” choice in Step 420 and, in response, in Step 430 the web server 11 returns a web page allowing entry of a sports “football” sub-lobby choice, “hockey” sub-lobby choice, “basketball” sub-lobby choice, “coach recently fired at MSU” sub-lobby choice and “drug testing” sub-lobby choice. For example, FIG. 17 depicts an exemplary web page with image maps with conventional displayed “buttons” corresponding to these choices. The first three choices, “football,” “hockey,” and “basketball,” refer to sub-topics of discussion involving particular sports within the broader category of the “sports” topic chosen in Step 420. The last two choices, “Coach fired at MSU” and “drug testing,” refer to sub-topics of conversation involving currently controversial sport-related issues within the broader category of the “sports” topic chosen. Also, as with FIG. 16, the web page also displays indicators showing the concentration of compatible friends and mates in each active sub-lobby within the chosen “sports” lobby. Again, the displayed indicators comprise one to three check marks reflecting the concentration of compatible mates and one to three green lights reflecting the concentration of compatible friends. And again, by providing for the display of indicators showing the concentration of likely compatible friends and mates, the dating related web site allows more informed user navigation to a desired chat room.

In an alternative embodiment, the user selects the music lobby in Step 420 and a sub-lobby screen such as that shown in FIG. 17a is displayed.

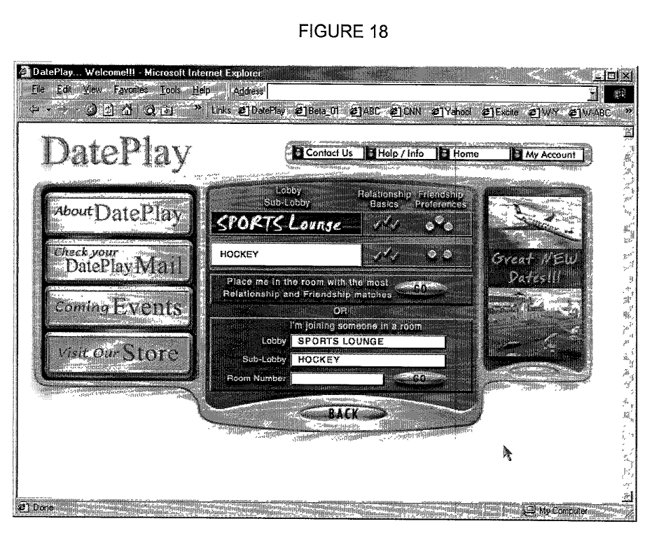

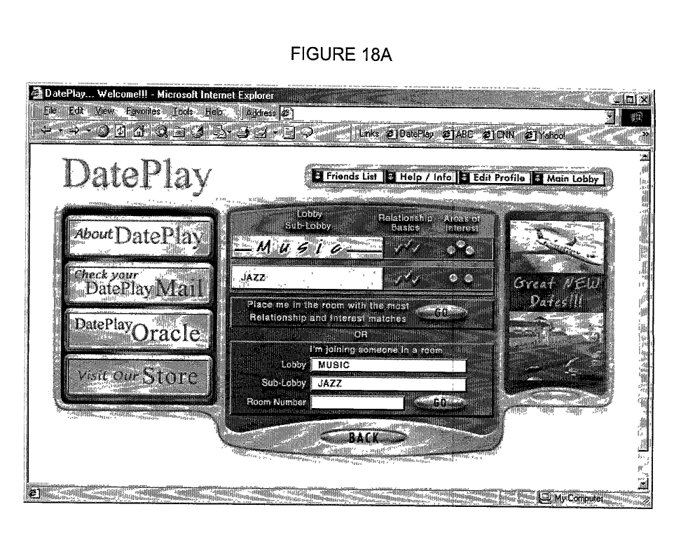

Getting back to the presently described embodiment, the user selects the “hockey” sub-lobby choice in Step 440 and, in response, in Step 450 the web server 11 returns a web page allowing a choice of either automatic navigation to a desired chat room within the chosen sub-lobby, or manual selection of a chat room within the chosen sub-lobby. For example, FIG. 18 depicts an exemplary web page with query form fields and image maps with conventional displayed “buttons” corresponding to these choices. (FIG. 18a shows a similar screen wherein the user instead specified the “music” lobby and “jazz” sub-lobby choices).

If the user specifies a room number in the query field and selects the manual navigation choice, the web server 11 determines a chat room in accordance with the user's choice in step 460. Otherwise if the user selects the automatic navigation choice, then in Step 470 the web server 11 determines a chat room using an algorithm for automatically determining a chat room within the selected sub-lobby having optimally compatible participants.

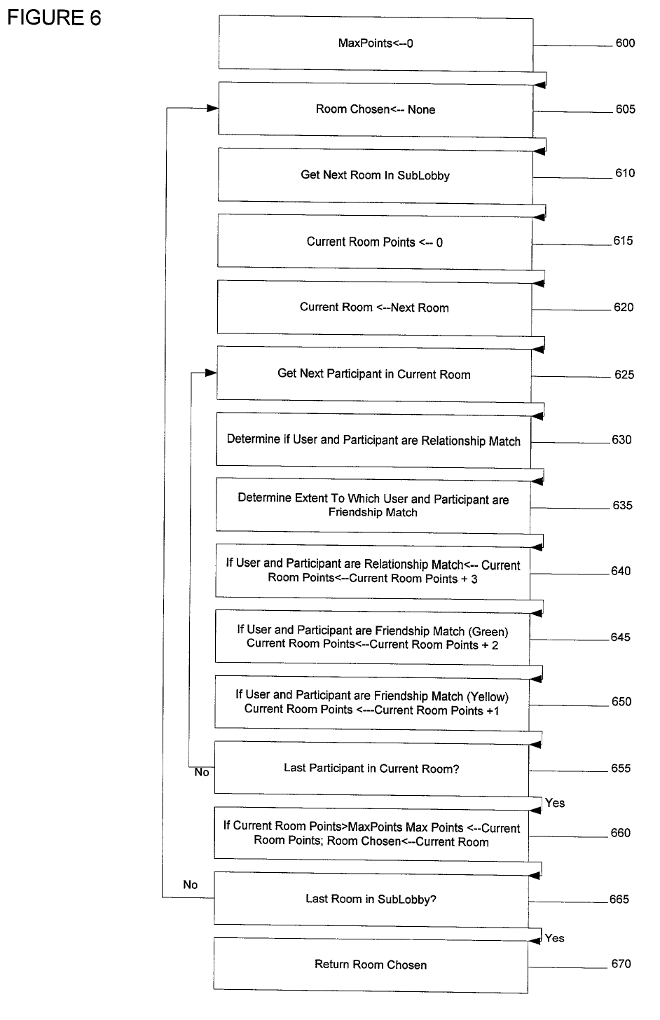

Turning now to FIG. 6, it shows an exemplary method for automatically determining for the user, given a selected sub-lobby, a chat room having optimally compatible participants. In particular, the exemplary process is initiated in Steps 600 and 605, with “MaxPoints” and “Room Chosen” variables initialized to zero and “none,” respectively.

Next in Step 610 the next room (that is, the first room in the first iteration) in the sub-lobby is retrieved by the web server 11. In Step 615 a “Room Points” variable for the retrieved room is set to zero and in Step 620 the current room is identified as the room retrieved.

Next in Step 625 the next participant (that is, the first participant in the first iteration) in the retrieved room is retrieved by the server 11. In Steps 630 and 635, the web server determines whether the user and the retrieved participant are a relationship match, the extent to which the user and the retrieved participant are likely compatible on a friendship level and whether or not the level of friendship compatibility exceeds certain thresholds.

Turning now to FIG. 7A, it shows in greater detail the step of determining whether there is a relationship match between the user and retrieved participant as depicted in Step 630 of FIG. 6. In particular, as depicted in Steps 700-730, the web server 11 uses the profiles of the retrieved participant and user to determine if either: a) the retrieved participant is not of the gender desired by the user; b) the retrieved participant is not within the age range desired by the user; c) the participant is outside a city the user desires to meet people in; d) the participant is outside the region the user desires to meet people in; e) the participant is outside the country the user desires to meet people in; f) the participant is a member of a religion the user stated he preferred not to date; or g) the participant is not a member of a religion the user stated he preferred to date. If all of these conditions are false, then in Step 735 a “Relationship Match” variable is set to true and in Step 745 the “Relationship Match” variable is returned indicating a relationship match between the user and participant. Otherwise, if any one of the conditions considered in Steps 700-730 is true, the “Relationship Match” variable is set to “false” in Step 740 and is returned in Step 745 indicating no relationship match exists between the user and participant.

Turning now to FIG. 7B, it shows in greater detail the step of determining the extent to which the user and the retrieved participant are compatible on a friendship level and whether or not the level of friendship compatibility exceeds certain thresholds as depicted in Step 635 of FIG. 6. In particular, in Steps 750 and 755, the “Points Earned” and “Points Possible” variables are initialized to zero.

In Steps 760 through 775, the web server 11 cycles through each area of interest specified by either the user or the participant. Such areas of interest (e.g., books, movies) are specified depicted in FIG. 14 and are stored in subscriber profiles as described earlier. In the presently described embodiment, the web server 11 or a database associated with the web server 11 also includes a database of associating weighting values (i.e., a number of points) with each area of interest. For “sports” may have an associated value of 50 points, while “books” may have an associated value of 100 points. The weighting value of the areas of in interest is a judgment that the site provider may make based on a variety of factors and effectively allows the site provider to prioritize the importance of areas interest with respect to the compatibility determination (e.g., having sports activities in common may be considered more important than having an interest in books in common). In Step 760, the web server 11 retrieves the next area of interest specified by either the user or participant. If both the user and the participant specified the area of interest (e.g., books), then in Step 765 the weight value of the area of interest is retrieved and added to the “Points Earned” variable value and to the “Points Possible” variable value. Otherwise, in Step 770, if only one of the user or participant have the area of interest in their profiles, only the “Points Possible” variable is incremented by the weight value of the area of interest. In Step 775, the web server 11 checks if there are other areas of interest specified by either the user or participant and, if so, processing begins again with Step 760 and continues until all areas of interest specified by either the user or the participant have been processed.

Next, in Steps 780 through 787, the web server 11 cycles through each of a set “area of interest combinations” stored at the web server 11 or an associated database. In the presently described embodiment, “area of interest combinations” are combinations comprising two areas of interest (e.g., hockey and skiing, movies and theatre) for which the site provider has provided an association. Preferably such associations are implemented with links in a relational database storing the area of interest combinations. In the presently described embodiment, the areas of interest combinations are created by the site provider to account for the fact that two individuals may have similar areas of interest even if they do not specify an identical area of interest. For example, a participant that specified “skiing” as an area of interest may have interests similar to a participant specifing other winter sports, such as “hockey” as an interest. If the site provider determines that this would in general be the case, then the area of interest combination “skiing-hockey” can be included in the relational database. Further, as with areas of interest, the web server 11 of the presently described embodiment, or a database associated with the web server 11, also includes records associating weighting values (i.e., a number of points) with each area of interest combination. For example, a “skiing-hockey” area of interest combination may have an associated point value of 20 points while a “movie-theatre” are of interest combination may have an associated point value of 10 points. As with the weighting of areas of interest, the weighting values associated with area of interest combinations allow the site provider to prioritize the importance of area interest combinations and their respective impact on the compatibility determination (e.g., if a first participant enjoys hockey while a second enjoys skiing, that fact may be considered more relevant than if the first participant enjoys movies while the second enjoys theatre). In Step 780, the web server 11 retrieves the next area of interest combination in a database. If the user specified one component of the area of interest combination pair while the participant specified the other component, then in Step 785 the weight value of the area of interest combination is retrieved and added to the “Points Earned” variable value and to the “Points Possible” variable value. In Step 790, the web server 11 checks if there are other area of interest combinations in the database storing this information and, if so, processing begins again with Step 780 and continues until all area of interest combinations in the database have been processed.

Next in Step 790, a “Percentage Match” variable is set to the “Points Earned” value divided by the “Points Possible” value. The “Percentage Match” variable indicates the degree to which there is a friendship compatibility between the user and participant. Next, in Step 792, the “Percentage Match” value is discretized by characterizing the level of friendship compatibility into one of three categories. That is, if the “Percentage Match” value is greater than or equal to a certain threshold value (e.g., 80%), then a “Friendship Match” variable is set to “green” indicating a high degree of friendship compatibility between the user and participant. Otherwise, if the “Percentage Match” value is less than the threshold value but greater than or equal to another threshold value (e.g., 60%), then the “Friendship Match” variable is set to “yellow” indicating a medium degree of friendship comaptibility between the user and participant. Otherwise, if the “Percentage Match” value is less than both threshold values, the “Friendship Match” variable is set to “red” indicating a low degree of friendship compatibility between the user and participant.

Note that the present invention is in no way intended to be limited to FIG. 7b. In alternative embodiments, the process of determining whether a user and retrieved participant are compatible friends may be implemented, perhaps more efficiently, using a single loop program structure, rather than a two loop program structure. For example, in the following psuedocode, data is stored for each registered player corresponding to that player's interest. The data is structured such that each such interest is also stored with four similar or often related interests, thus also specifying four area of interest combinations formed partly by the players interest. For example, the following:

Interests=[1 (Animals and Pets), [37(Recreation), 33(Parenting), 23(Horses), 19(Environmental)]] represents data stored for one registered player representing one of the player's interests (animals and pets) as well as four other interests that may often be correlated with a love of animal and pets. Once such a data structure with corresponding data is created for each interest for each player, the following may be used to determine whether a user and retrieved participant are compatible friends:

```
Points_for_Green = 200
Points_for_Yellow = 100
Points_for_Match = 100
Points_for_A1 = 70
Points_for_A2 = 40
Points_for_A3 = 20
Points_for_A4 = 10
For each person
  Load all of the person's interests
For each person (P1)
  For each other person (P2)
```

Initialize Score for P1_P2 to 0
For each interest that P1 has (I)

If P2 has interest I, add Points_for_Match to Score for P1_P2
Else If P2 has A1, add Points_for_A1 to Score for P1_P2
Else If P2 has A2, add Points_for_A2 to Score for P1_P2
Else If P2 has A3, add Points_for_A3 to Score for P1_P2
Else If P2 has A4, add Points_for_A4 to Score for P1_P2

If Score for P1_P2 >= Points_for_Green then

The light for P2 on P1‘s screen will be green

Else If Score for P1_P2 >= Points_for_Yellow then

The light for P2 on P1's screen will be yellow

else

The light for P2 on P1's screen will not show up

Turning back now to the automatic navigation algorithm of FIG. 6, having determined a value for the “Relationship Match” and “Friendship Match” variables in Steps 630 and 635 (and as detailed in FIGS. 7A and 7B), in Step 640 the web server 11 next increments the “Room Points” value for the retrieved room by three if “Relationship Match” has a value of “true.” In Step 645, the web server 11 increments the “Room Points” value for the retrieved room by two if “Friendship Match” has a value of “green.” Similarly, in Step 650, the web server 11 increments the “Room Points” value for the retrieved room by one if “Friendship Match” has a value of “yellow.” If none of these conditions apply, then the “Room Points” value for the retrieved room is not incremented as a result of processing of the participant retrieved in Step 625.

In Step 655 the server 11 checks whether the participant retrieved in Step 625 is the last participant in the retrieved room. If there are additional participants, Steps 625-655 are repeated so that all participants in the retrieved room are processed.

Once all participant in the retrieved room have been processed, in Step 660, the server 11 determines whether the value of “Room Points” for the retrieved room exceeds the value currently stored in the “MaxPoints” variable. (Note that this condition will always be satisfied for the first room retrieved in the process depicted in FIG. 6). If so, then the “MaxPoints” variable is set to the “Room Points” value for the retrieved room and the “Room Chosen” variable is set to the retrieved room. Next in Step 665 the server 11 determines whether the retrieved room is the last to be processed in the selected sub-lobby. If there are additional rooms in the selected sub-lobby, then steps 610 through 660 are repeated until all rooms in the selected sub-lobby have been retrieved and processed. In this way, “MaxPoints” is always set to the “RoomPoints” value for the room having the greatest “Room Points” while “Room Chosen” is assigned a value identifying that room.

Finally, in Step 670 the “Room Chosen” variable is returned as an indicator of the chat room having the most optimally compatible participants.

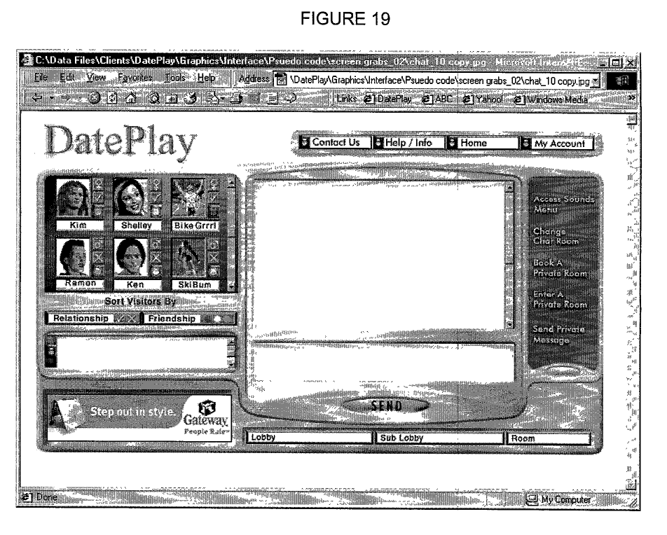

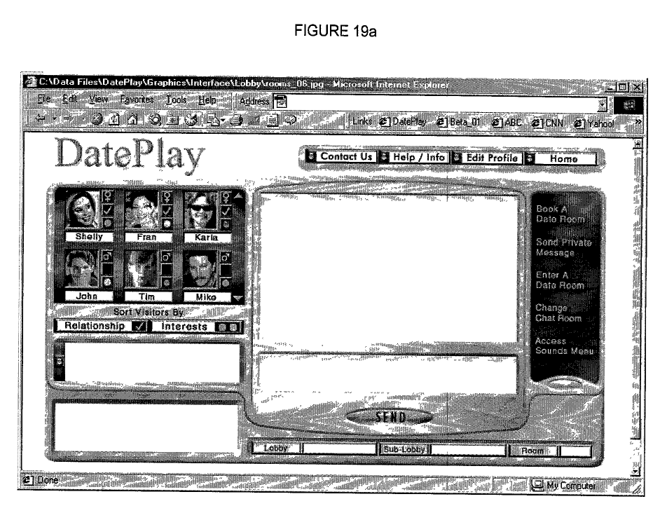

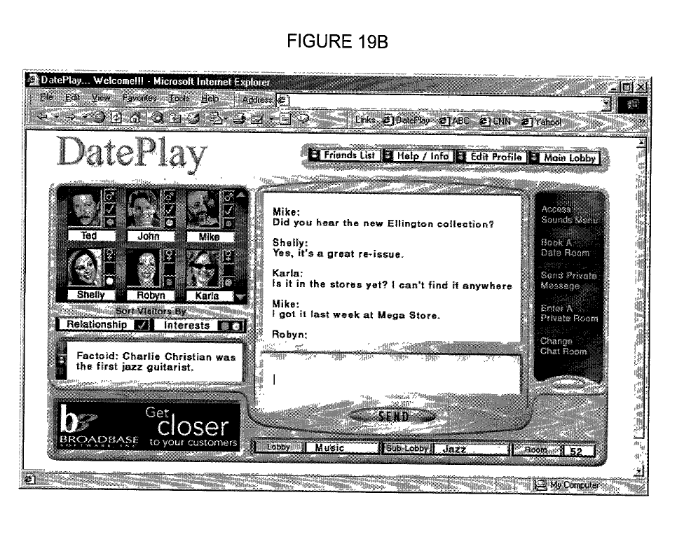

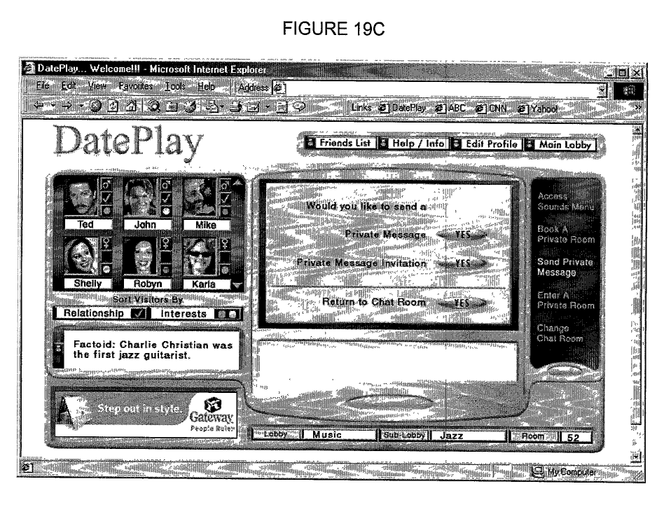

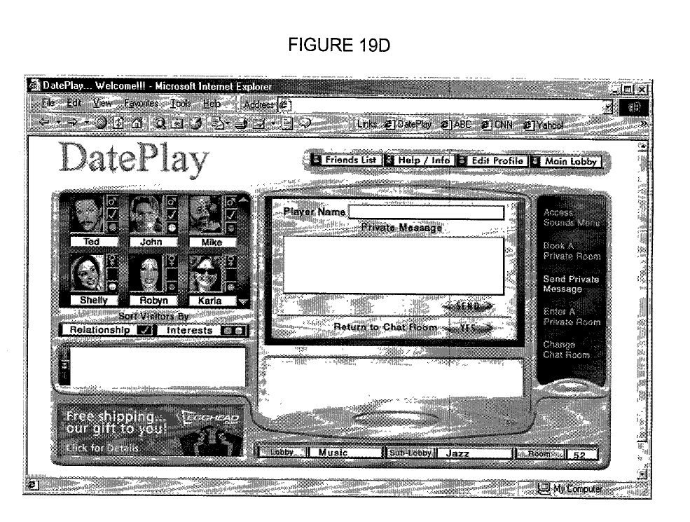

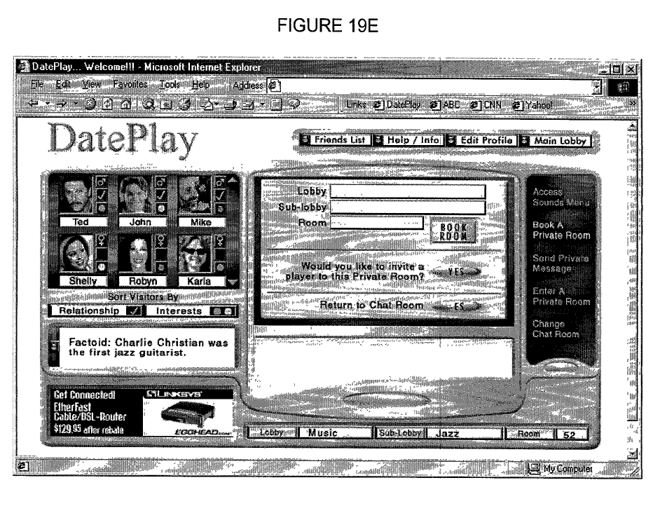

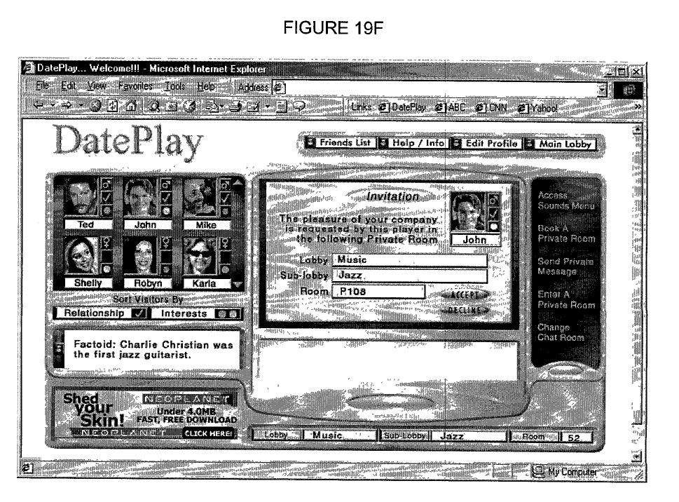

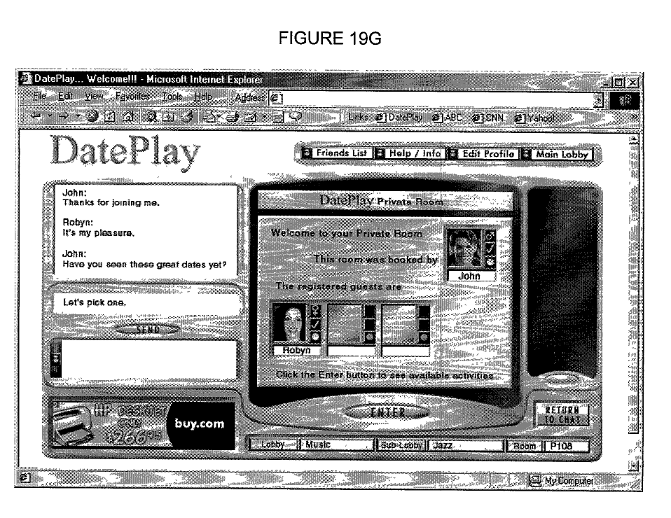

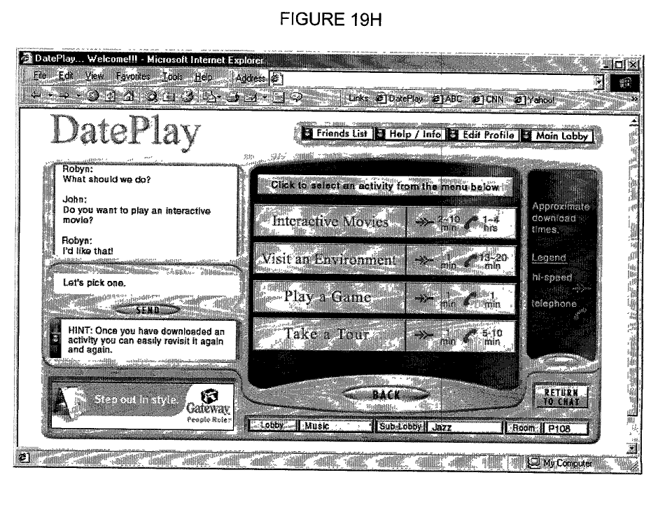

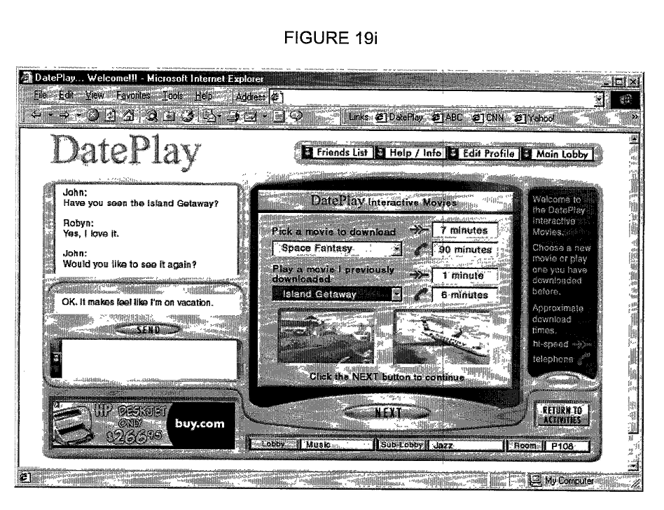

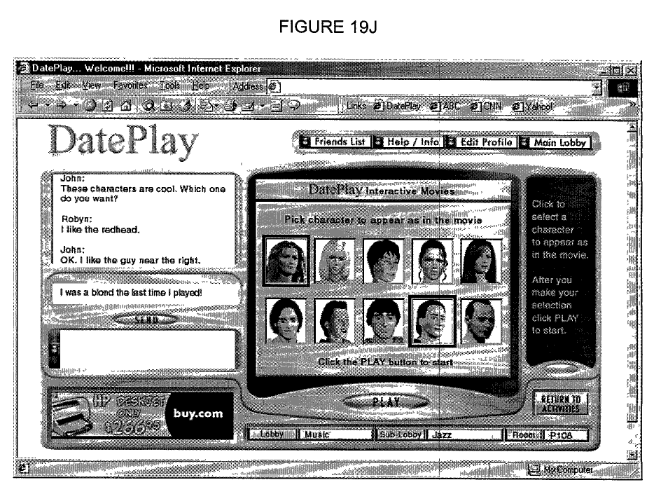

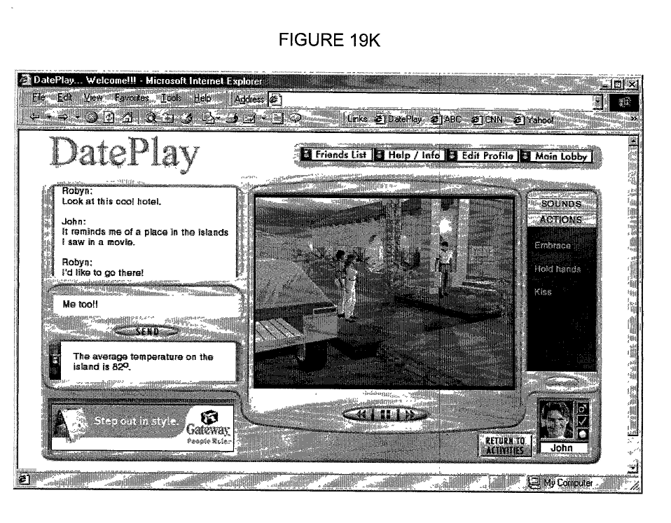

Turning back to the user navigation process of FIG. 4, in Step 480, once the chat room is determined, whether automatically in accordance with the “Room Chosen” variable discussed in connection with FIG. 6 or manually by the user, the web server 11 (or a chat server) finally serves a page representation of a chat room environment corresponding to the chat room determined in Step 460 or 450. (The page representing a chat room environment may also be generated locally by chat software on the client 99. In addition note that the chat server and web server may represent respective software components on a single physical server). An exemplary page representing a chat environment and facilitating an Internet relay in accordance with the presently described embodiment is shown in FIGS. 19 an 19a.

Internet Relay Chat is known in the art as a conventional way for Internet subscribers to “chat” with one another via keyboards 195 in real time. To facilitate this process, the client 20 may have any chat client software installed thereon that connects to a chat server. In the presently described embodiment, the user's client 20 has chat client software installed that may be downloaded from the dating related web site in conventional fashion. The client 20 is also connected and logged on to a chat server and channel upon receipt of the chat room page of Figurel9 and 19a. In FIGS. 19 and 19c, the messages are viewed from the large center window depicted.

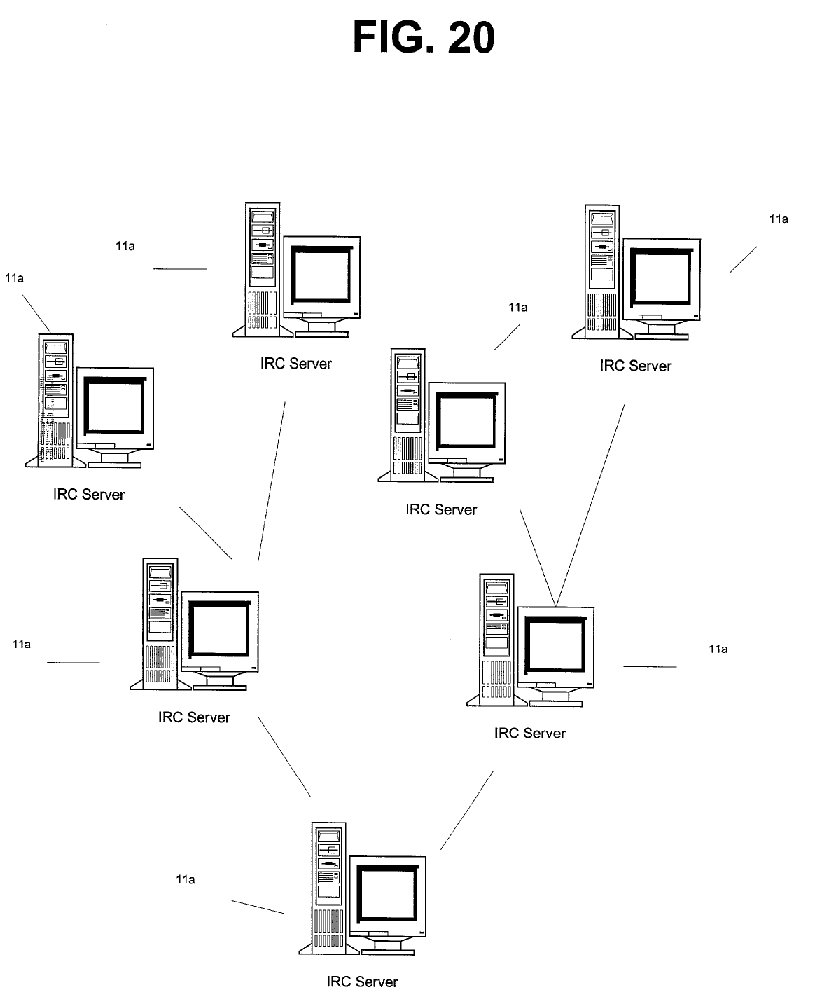

In conventional fashion, the chat server is connected in the Internet with other chat servers in conventional “spanning tree” fashion (shown in FIG. 20) to speed the transmission of participant messages from server to server. User messages are sent from the keyboard 195 by the client chat software to the connected chat server and are then broadcast from chat server to other chat servers to which participants have access. Messages are thus broadcast to the client software of other participants logged in to the chat room selected in real time, and such participants have the same ability to generate and broadcast messages.

In the presently described embodiment, as in a typical chat room environment, each message is associated with a handle identifying the sender of the message. In the chat environment depicted in FIG. 19, the screen names (e.g., “kim,” “shelly,” “ken”) stored in participant user files function as such handles. Further, in an advantageous aspect of the present invention, in addition to screen names, the screen image icons stored in participant profiles are also associated with the chat participants in the chat environment depicted in FIG. 19. (Again, these icons may represent pre-defined icons that allow the participants to maintain anonymity, or actual photos of the participants as shown in the alternative chat room environment depicted in FIG. 19). Further as depicted in FIG. 19, in the exemplary chat environment illustrated, if there is a relationship match between the user and a participant, then a checkmark will be shown in the relationship possibility indicator displayed with the screen icon, screen name and gender of the participant. In the presently described embodiment, the web server 11 determines whether there is a relationship match among chat participants in accordance with the exemplary algorithm discussed in connection with FIG. 7A. In alternative embodiments, a separate chat server performs those functions required to facilitate chat functionality. Similarly, if there is a friendship match between the user and a participant, then a green light will be shown in the friendship possibility indicator displayed with the screen icon, screen name and gender of the participant. Again, in the presently described embodiment, the web server 11 may determine the extent of friendship compatibility among chat participants and whether that compatibility exceeds a threshold indicating a friendship match (i.e., “green”) in accordance with the exemplary algorithm discussed in connection with FIG. 7B.

In a further advantageous aspect of a chat environment featured in the presently described embodiment, the web server 11 (or chat server) will continually monitor the profiles of all players on the system and advise the participants when rooms develop that have more Friendship or Relationship matches than the chat in which they are currently participating. This determination may be derived by repeatedly executing an algorithm such as the exemplary algorithm discussed in connection with FIG. 5.

Also, in yet another advantageous aspect of a dating related web site in accordance with an embodiment of the present invention, if the user engages in chat (FIG. 19bshows a series of chat messages among participants) and finds a chat participant desirable, the user and that participant may choose to take advantage of a “virtual date” feature.

In particular, apart from the “Send” button for sending normal chat messages, the screen in FIG. 19b also features a “Send Private Message” button. When the user selects the button while participating in a chat session, the web server 11 (or chat server) responds by forwarding data corresponding to a screen such as that shown in FIG. 19c. Next, in the presently described embodiment, the user elects to send a private message and a “Send a Private Message Screen” is caused to be served from the web sever 11 (or chat server). An exemplary screen interface is depicted in FIG. 19d. This screen allows the user to specify a private message which is sent to only the recipient indicated in the “Player Name” field. Upon selection of the “Send” button, the client computer generates packets comprising the specified message destined for the web server 11 (or chat server(s)). The web server (chat server 11) maintains a network address listing for the computer of each participant in the chat room and maintains associations between participant identifiers and corresponding network addresses in accordance with techniques known in the art. Thus, the web server (chat server) 11 can complete the private message by causing the message to be sent only to the computer corresponding to the recipient specified by the sender. In this way, participants can conduct private virtual conversations that may express interests and feelings they do not wish to make public.

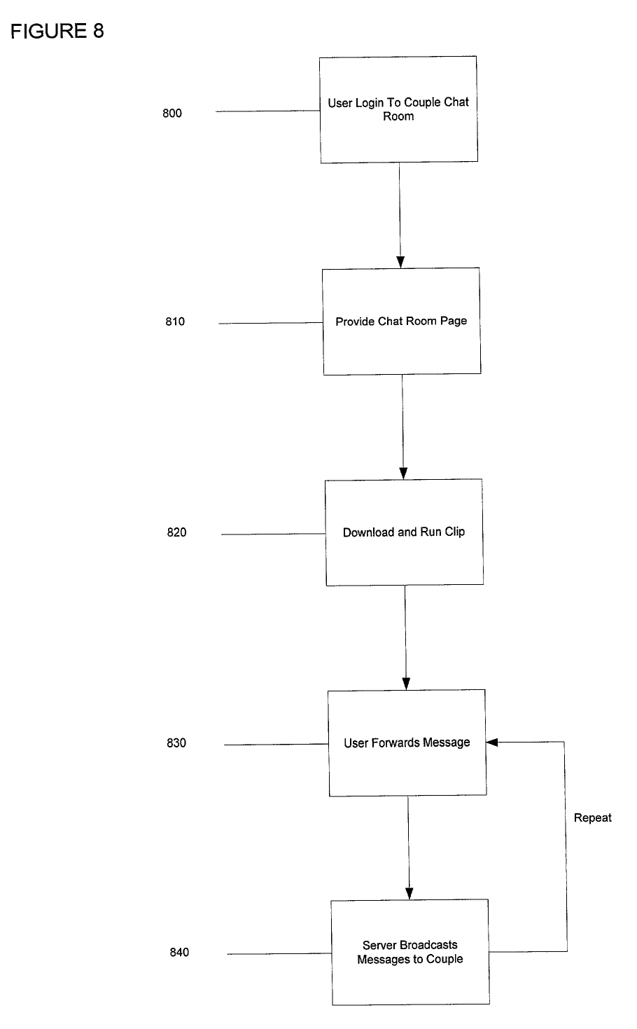

Once participants engage in such a private conversation, they may decide to use the sites virtual dating facility. Thus, turning now to FIG. 8, in Step 800, one of the two conversants decides to book a private room. To do so, the player selects the “Book a Private Room” button shown in FIG. 19d. In response the web server 11 (chat server) serves data corresponding to a screen such as that shown in FIG. 19e. The screen gives the player the option of booking a room and inviting another player to the private room.

In response, the web server 11 (chat server) causes a screen such as that depicted in FIG. 19f to be served to the invited player's computer. Again, this is accomplished as the web server 11 maintains lists of network addresses and corresponding participants for each participant in the chat room.

In the present described embodiment, the invite player selects the “Accept” button. In response, in Step 810, data corresponding to a screen such as that shown in FIG. 19g is served to both players' computers. The page allows the players to engage in a private chat.

When either player clicks “Enter” to proceed, an interface such as that shown in FIG. 19h is displayed on both player screens. The screen provides choices corresponding to virtual activities the players may engage in. Again, all the while the while (chat) server 11 allows the players to participate in a private chat. In this way, the players can discuss a choice before making it.

In the presently described embodiment, one of the players selects the “Interactive Movies” selection. As result, a screen such as that shown in FIG. 19i is displayed on both player screens. The interface allows the players to select the interactive movie clip, or “Virtual Date,” that the players wish to see. For example, the players may select an “Island Getaway” vacation or a “Space Fantasy” vacation. In the presently described embodiment, an interface such as that depicted in FIG. 19j is also displayed on the player screens allowing each player to specify an icon that will represent them during he course of their “virtual date.”

In response to the players' selections, in Step 830, a digital video clip corresponding to the choice is downloaded and executed on both player client computers using techniques known in the art. In the presently described embodiment, the clip also displays two icons—one male and one female—hat are displayed as taking part in the video clip. In one embodiment of the present invention, the players respective icons respond in interactive fashion-that is, the icons are controlled by each player. For example, in some scenes a layer could elect to initiate a ‘hug’ action which would cause the screens to both players to show a ‘hug’ sequence. In this embodiment, the interactive movies also include sound effects that can be initiated by one player and heard by both. In addition, the both players are given the continued ability to engage in private chat as depicted in the upper left corner of FIG. 19k and Steps 830 and 840 of FIG. 8.

From this description, it should be readily apparent that numerous other modifications and combinations of the above disclosure may be made without departing form the scope of the present invention. For example, while the above disclosure refers to a single web server 11 or chat server, the algorithms described may be implemented on any number of nodes with or without web server or chat server software. Further, the algorithms and processes are intended as specific implementations only and are not intended to delimit the scope of the invention, which should instead be understood with reference to the following claims.

What is claimed is:

1. A method for facilitating a chat service from a web site, the web site consisting of web pages and executable program routines stored on an http server, the http server coupled via a computer network to a plurality of subscriber computers each operated by at least one of the subscribers, the method comprising:
a. transmitting a web page to one of the subscriber computers, the web page including a hypertext link corresponding to a chat environment;
b. receiving a request for the chat environment from the one of the subscriber computers;
c. causing the chat environment to be generated on the one of the subscriber computers, the chat environment depicted as a chat environment on a display device associated with the one of the subscriber computers when processed by an application program operating on the one of the subscriber computers, the depicted chat environment including an area for chat messages, a plurality screen images, each one of the plurality of screen images associated with a corresponding chat participant, and a plurality of compatibility indicator sets, each one of the indicator sets associated with a corresponding chat participant; and
d. facilitating the establishment of a connection between the one of the subscriber computers and a chat server such that the one of the subscriber computers is logged onto a chat a channel corresponding to the generated chat environment:

2. The method of claim 1 wherein the request includes a chat room number where the chat environment and chat channel correspond to the chat room number.

3. The method of claim 1 wherein the hypertext link is incorporated in an image map, the image map being incorporated in the web page.

4. The method of claim 3 wherein the image map is depicted as a button on the display device when processed by the web browser.

5. The method of claim 2 where the chat room number corresponds to one of a plurality of chat room identifiers, the plurality of chat room identifiers stored in a database connected to the http server.

6. The method of claim 5 wherein the chat room identifiers are organized in the database in a hierarchy of lobbies and sub-lobbies.

7. The method of 6 wherein the lobbies correspond to stored topic of conversation data.

8. The method of claim 6 wherein the sub-lobbies each correspond to sub-topic of conversation data, the sub-topic of conversation data corresponding to the topic of conversation data of one of the lobbies.

9. The method of claim 1 wherein each one of the compatibility indicator sets comprise a friendship indicator and a relationship indicator.

10. The method of claim 9 further comprising the step of determining the friendship indicator by comparing retrieved profile data for a user corresponding to the one of the subscriber computers with retrieved profile data for the corresponding chat participant.

11. The method of claim 10 wherein the retrieved profile data comprises data reflecting specified areas of interest.

12. The method of claim 9 further comprising the step of determining the friendship indicator by checking retrieved profile data for a user corresponding to the one of the subscriber computers and retrieved profile data for the corresponding chat participant to determine whether the user and chat participant share an area of interest combination.

13. The method of claim 9 further comprising the step of determining the relationship indicator by comparing retrieved profile data for a user corresponding to the one of the subscriber computers with retrieved profile data for the corresponding chat participant.

14. The method of claim 13 wherein the retrieved profile data comprises data reflecting qualities desired in a mate.

15. A method for facilitating a chat service from a web site, the web site consisting of web pages and executable program routines stored on a server, the server coupled via a computer network to a plurality of subscriber computers each operated by at least one of the subscribers, the method comprising:
a. transmitting a web page to one of the subscriber computers, the web page including a hypertext link corresponding to a chat environment;
b. receiving a request for the chat environment from the one of the subscriber computers;
c. causing the chat environment to be generated on the one of the subscriber computers, the chat environment depicted as a chat environment on a display device associated with the one of the subscriber computers when processed by an application program operating on the one of the subscriber computers, the depicted chat environment including an area for chat messages, a plurality screen images, each one of the plurality of screen images associated with a corresponding chat participant, and a plurality of compatibility indicator sets, each one of the indicator sets associated with a corresponding chat participant; and
d. facilitating the establishment of a connection between the one of the subscriber computers and a chat server such that the one of the subscriber computers is logged onto a chat a channel corresponding to the generated chat environment.

16. The method of claim 15 wherein the request includes a chat room number where the chat environment and chat channel correspond to the chat room number.

17. The method of claim 15 wherein the hypertext link is incorporated in an image map, the image map being incorporated in the web page.

18. The method of claim 17 wherein the image map is depicted as a button on the display device when processed by the web browser.

19. The method of claim 16 where the chat room number corresponds to one of a plurality of chat room identifiers, the plurality of chat room identifiers stored in a database connected to the server.

20. The method of claim 19 wherein the chat room identifiers are organized in the database in a hierarchy of lobbies and sub-lobbies.

21. The method of 20 wherein the lobbies correspond to stored topic of conversation data.

22. The method of claim 20 wherein the sub-lobbies each correspond to sub-topic of conversation data, the sub-topic of conversation data corresponding to the topic of conversation data of one of the lobbies.

23. The method of claim 15 wherein each one of the compatibility indicator sets comprise a friendship indicator and a relationship indicator.

24. The method of claim 23 further comprising the step of determining the friendship indicator by comparing retrieved profile data for a user corresponding to the one of the subscriber computers with retrieved profile data for the corresponding chat participant.

25. The method of claim 24 wherein the retrieved profile data comprises data reflecting specified areas of interest.

26. The method of claim 23 further comprising the step of determining the friendship indicator by checking retrieved profile data for a user corresponding to the one of the subscriber computers and retrieved profile data for the corresponding chat participant to determine whether the user and chat participant share an area of interest combination.

27. The method of claim 23 further comprising the step of determining the relationship indicator by comparing retrieved profile data for a user corresponding to the one of the subscriber computers with retrieved profile data for the corresponding chat participant.

28. The method of claim 27 wherein the retrieved profile data comprises data reflecting qualities desired in a mate.

29. A method for facilitating a chat service from a web site, the web site consisting of web pages and executable program routines stored on an http server, the http server coupled via a computer network to a plurality of subscriber computers each operated by at least one of the subscribers, the method comprising:
a. retrieving profile data for a plurality of chat participants, each one of the participants being one of the subscribers logged onto one of a plurality of chat channels;
b. determining a compatibility value for each one of the plurality of chat channels in relation to a user subscriber using the retrieved profile data;
c. determining a one of the plurality of chat channels having an optimal compatibility value;
d. causing to be generated a chat environment corresponding to the one of the plurality of chat channels on one of the subscriber computers corresponding to the user subscriber, the chat environment depicted as a chat environment on a display device associated with the one of the subscriber computers when processed by an application program operating on the one of the subscriber computers, the depicted chat environment including an area for chat messages; and
e. facilitating the establishment of a connection between the one of the subscriber computers and a chat server such that the one of the subscriber computers is logged onto the one of the plurality of chat channels.

30. The method of claim 29 wherein the retrieved profile data comprises data reflecting specified areas of interest.

31. The method of claim 29 wherein the retrieved profile data comprises data reflecting qualities desired in a mate.

32. The method of claim 29 wherein the step of determining a compatibility value for each one of the plurality of chat channels in relation to a user subscriber also comprises using area of interest combination data.

33. A method for facilitating a chat service from a web site, the web site consisting of web pages and executable program routines stored on a server, the server coupled via a computer network to a plurality of subscriber computers each operated by at least one of the subscribers, the method comprising:
a. retrieving profile data for a plurality of chat participants, each one of the participants being one of the subscribers logged onto one of a plurality of chat channels;
b. determining a compatibility value for each one of the plurality of chat channels in relation to a user subscriber using the retrieved profile data;
c. determining a one of the plurality of chat channels having an optimal compatibility value;
d. causing to be generated a chat environment corresponding to the one of the plurality of chat channels on one of the subscriber computers corresponding to the user subscriber, the chat environment depicted as a chat environment on a display device associated with the one of the subscriber computers when processed by an application program operating on the one of the subscriber computers, the depicted chat environment including an area for chat messages; and
e. causing the one of the subscriber computers to be logged onto the one of the plurality of chat channels.

34. The method of claim 33 wherein the retrieved profile data comprises data reflecting specified areas of interest.

35. The method of claim 33 wherein the retrieved profile data comprises data reflecting qualities desired in a mate.

36. The method of claim 33 wherein the step of determining a compatibility value for each one of the plurality of chat channels in relation to a user subscriber also comprises using area of interest combination data.

37. A method for facilitating a virtual date service from a server, the server coupled via a computer network to a plurality of subscriber computers each operated by at least one of the subscribers, the method comprising:
a. transmitting a chat environment to one of the subscriber computers, the chat environment depicted as a chat environment on a display device associated with the one of the subscriber computers when processed by an application program operating on the one of the subscriber computers, the depicted chat environment including an area for chat messages;
b. transmitting a copy of the chat environment to another of the subscriber computers;
c. facilitating the establishment of a connection between the one of the subscriber computers and the server such that the one of the subscriber computers is logged onto a chat channel; and
d. facilitating the establishment of a connection between the another of the subscriber computers and the server such that the another of the subscriber computers is logged onto the chat channel.

38. The method of claim 37 further comprising the step of transmitting a video clip file to the one of the subscriber computers and the another of the subscriber computers, the video clip executable on the one of the subscriber computers and the another of the subscriber computers.

39. A server having a web site comprised of web pages and chat environments stored thereon, the server coupled to a plurality of client computers, the web site serving a subscriber community having a plurality of members, the web pages being accessible to the plurality of members, the server comprising:
a. a central processing unit with associated memory;
b. a chat environment software element comprising instructions residing in the memory, that when executed by the central processing unit, functions to:
i. retrieve profile data for a plurality of chat participants, each one of the chat participants being logged onto one of a plurality of chat channels;
ii. determine a compatibility value for each one of the plurality of chat channels in relation to a user subscriber using the retrieved profile data;
iii. determine a one of the plurality of chat channels having an optimal compatibility value;
iv. transmit a chat environment corresponding to the one of the plurality of chat channels to one of the client computers; and
v. facilitate the establishment of a connection between the one of the client computers and a chat server such that the one of the client computers is logged onto the one of the plurality of chat channels; and
c. a virtual date software element comprising instructions residing in the memory, which when executed by the central processing unit, functions to:
i. transmit a chat environment to first of the client computers, the depicted chat environment including an area for chat messages;
ii. transmit a copy of the chat environment to a second of the client computers;
iii. facilitate the establishment of a connection between the first of the client computers and a chat server such that the first of the client computers is logged onto a private chat channel;
iv. facilitate the establishment of a connection between the second of the client computers and the chat server such that the second of the client computers is logged onto the private chat channel; and
v. transmit a video clip file to the first and second client computers, the video clip executable on the first and second client computers.

40. A server having a web site comprised of web pages and chat environments stored thereon, the server coupled to a plurality of client computers, the web site serving a subscriber community having a plurality of members, the web pages being accessible to the plurality of members, the server comprising:
a. a central processing unit with associated memory;
b. a chat environment software element comprising instructions residing in the memory, that when executed by the central processing unit, functions to:
i. retrieve profile data for a plurality of chat participants, each one of the chat participants being logged onto one of a plurality of chat channels;
ii. determine a compatibility value for each one of the plurality of chat channels in relation to a user subscriber using the retrieved profile data;
iii. determine a one of the plurality of chat channels having an optimal compatibility value;
iv. transmit a chat environment corresponding to the one of the plurality of chat channels to one of the client computers; and
v. facilitate the establishment of a connection between the one of the client computers and a chat server such that the one of the client computers is logged onto the one of the plurality of chat channels.

41. A web server having a web site comprised of web pages and chat environments stored thereon, the web server coupled to a plurality of client computers, the web site serving a subscriber community having a plurality of members, the web pages being accessible to the plurality of members, the server comprising:
a. a central processing unit with associated memory;
b. a virtual date software element comprising instructions residing in the memory, which when executed by the central processing unit, functions to:
i. transmit a chat environment to first of the client computers, the depicted chat environment including an area for chat messages;
ii. transmit a copy of the chat environment to a second of the client computers;
iii. facilitate the establishment of a connection between the first of the client computers and a chat server such that the first of the client computers is logged onto a private chat channel;
iv. facilitate the establishment of a connection between the second of the client computers and the chat server such that the second of the client computers is logged onto the private chat channel; and
v. transmit a video clip file to the first and second client computers, the video clip executable on the first and second client computers.

42. A method for determining the compatibility between two subscribers in a community of web site subscribers, the first of the two subscribers having a first user profile stored in a first database, the second of the two subscribers having a second user profile stored in the first database, the method comprising:
a. retrieving data corresponding to a first area of interest from the first user profile;
b. retrieving data corresponding to a second area of interest from the second user profile;
c. incrementing a compatibility value as a function of whether the first area of interest matches the second area of interest;
d. incrementing the compatibility value as a function of whether the first area of interest matches a first component of an area of interest combination stored in a second database and the second area of interest matches a second component of the area of interest combination; and
e. determining the compatibility between the first and second subscribers as a function of the compatibility value.

43. The method of claim 42 wherein the first and second databases are the same.
